(19) United States
(12) Patent Application Publication
(10) Pub. No.: US 2024/0058754 A1
(43) Pub. Date: Feb. 22, 2024

(54) SUPER-HIGH-PERMEANCE THIN-FILM COMPOSITE NANOFILTRATION MEMBRANE INCORPORATING SILK NANOFIBER INTERLAYER

(71) Applicant: The University of Hong Kong, Hong Kong (CN)

(72) Inventors: Bowen Gan, Hong Kong (CN); Zhe Yang, Hong Kong (CN); Chuyang Tang, Hong Kong (CN)

(21) Appl. No.: 18/345,284

(22) Filed: Jun. 30, 2023

Related U.S. Application Data
(60) Provisional application No. 63/371,548, filed on Aug. 16, 2022.

(51) Int. Cl. B01D 61/02; B01D 61/08; B01D 67/00; B01D 69/02; B01D 69/10; B01D 69/12; B01D 71/56; B01D 71/74; C02F 1/44

(52) U.S. Cl. CPC B01D 61/027; B01D 61/08; B01D 67/0006; B01D 69/02; B01D 69/107; B01D 69/1213; B01D 71/56; B01D 71/74; C02F 1/442; B01D 2315/06; B01D 2323/26; B01D 2325/02833; B01D 2325/02834; B01D 2325/04; B01D 2325/20; B01D 2325/40

(57) ABSTRACT

Nanofiltration membranes and methods of using and making thereof are disclosed. The nanofiltration membranes contain a silk layer, a porous substrate, and a selective layer. The silk layer is an interlayer sandwiched between the porous substrate and selective layer. The nanofiltration membranes have high performance for filtering water, such as improved water permeance and/or high ion removal rate. For example, the nanofiltration show a water permeance that is at least 2-fold, such as about 5-fold, of the water permeance of a commercially available nanofiltration membrane, such as DuPont FilmTec™ NF270 and/or DuPont FilmTec™ NF90, and an ion rejection of at least 70% against a target ion, such as a divalent or multivalent ion. The greatly improved water permeance of the nanofiltration membranes can result in up to a magnitude lower energy consumption in water filtration applications.

### CROSS-REFERENCE TO RELATED APPLICATIONS

This application claims the benefit of and priority to U.S. Application No. 63/371,548, filed Aug. 16, 2022, which is specifically incorporated by reference herein in its entirety.

### FIELD OF THE INVENTION

This invention is generally in the field of nanofiltration membrane and methods of making and using hereof.

### BACKGROUND OF THE INVENTION

Nanofiltration (NF) is an emerging technology in water purification, wastewater treatment, and seawater desalination. Comparing with traditional technologies, nanofiltration offers many benefits including low operation cost, reduced energy consumption, and avenues for integrated and environmentally friendly processing.

Progress has been made to improve this technology in industrial applications. However, many problems still exist, for example, membrane fouling, low membrane stabilities and durability, and low membrane water permeance. For example, commercial NF membranes, such as DuPont FilmTec™ NF270 and DuPont FilmTec™ NF90, typically have relatively low water permeance on the order of or below 15 L m⁻² h⁻¹ bar⁻¹, which could result in high energy consumption in various water/wastewater treatments.

There remains a need to develop nanofiltration membranes having improved features for filtering water.

Therefore, it is an object of the present invention to provide nanofiltration membranes with improved water permeance.

It is a further object of the present invention to provide water filtration systems containing the nanofiltration membranes with improved water permeance.

It is a further object of the present invention to provide methods for making the nanofiltration membranes with improved water permeance.

It is a further object of the present invention to provide methods for using the nanofiltration membranes with improved water permeance.

### SUMMARY OF THE INVENTION

Described are nanofiltration membranes for filtering water with high performance, such as improved water permeance and/or high ion removal rate. Also described are methods of making and using the nanofiltration membranes, and water filtration systems incorporating the nanofiltration membranes.

The high-performance nanofiltration membranes disclosed herein can supply water, such as safe drinking water, with high productivity and high removal efficiency against a wide spectrum of contaminants, such as sulfate, magnesium, calcium, etc. The disclosed nanofiltration membranes can be used in a variety of applications, such as seawater desalination pretreatment, surface water treatment, ground water treatment, water softening, water reuse, and industrial wastewater treatment and wastewater reclamation. In some forms, the nanofiltration membranes disclosed herein show improved water permeance and/or high target ion/contaminant removal rate (i.e. an ion/contaminant rejection rate of≥70% against a target ion/contaminant, such as a divalent ion or multivalent ion, for example, sulfate ion, magnesium ion, calcium ion, etc.). For example, the nanofiltration membranes disclosed herein show a water permeance that is at least 2-fold, at least 3-fold, at least 4-fold, or at least 5-fold of the water permeance of a commercially available nanofiltration membrane, such as DuPont FilmTec™ NF270 and/or DuPont FilmTec™ NF90, when tested under the same condition. Such greatly improved water permeance can result in up to a magnitude lower energy consumption in water filtration applications, such as those listed above.

The nanofiltration membrane includes a silk layer, and optionally a porous substrate and/or a selective layer. For example, the nanofiltration membrane contains a silk layer and a porous substrate, where a first surface of the silk layer is in contact with a first contact surface of the porous substrate. For example, the nanofiltration membrane contains a silk layer, a porous substrate, and a selective layer, where a first surface of the silk layer is in contact with a first contact surface of the porous substrate, and a second surface of the silk layer is in contact with a second contact surface of the selective layer, wherein the second surface of the silk layer is opposite the first surface of the silk layer.

Typically, the silk nanomaterials in the nanofiltration membranes are fibroin. The silk nanomaterials can be in a variety of forms, such as fibers, foams, meshes, or sponges, or a combination thereof. For example, the silk nanomaterials are in the form of silk fibers, such as silk nanofibers. When the silk nanomaterials are silk fibers, they can have an average diameter in a range from about 10 μm to about 60 μm, from about 10 μm to about 50 μm, from about 10 μm to about 40 μm, from about 10 μm to about 30 μm, or from about 20 μm to about 40 μm.

The silk layer of the nanofiltration membranes may further contain a collogen or a polymer, or a combination thereof. When collogen is used to form the silk layer, the collogen can be in the form of fibers, foams, meshes, or sponges, or a combination thereof. Generally, the silk layer is porous with an average pore diameter in a range from about 10 nm to about 1.5 μm, from about 20 nm to about 1.2 μm, from about 20 nm to about 0.8 μm, from about 20 nm to about 0.6 μm, from about 50 nm to about 1.5 μm, from about 50 nm to about 1.0 μm, from about 50 nm to about 0.8 μm, from about 0.1 μm to about 1.5 μm, from about 0.2 μm to about 1.5 μm, or from 0.5 μm to about 1.5 μm, and/or has a thickness in a range from about 100 nm to about 100 μm, from about 1 μm to about 100 μm, from about 10 μm to about 100 μm, from about 10 μm to about 80 μm, from about 20 μm to about 100 μm, or from about 20 μm to about 80 μm.

The silk layer has a high transport rate, such as in a range from about 160 L m⁻² h⁻¹ bar⁻¹ to about 16000 L m⁻² h⁻¹ bar⁻¹, from about 500 to about 16000 L m⁻² h⁻¹ bar⁻¹, from about 1000 to about 16000 L m⁻² h⁻¹ bar⁻¹, from about 1600 to about 16000 L m⁻² h⁻¹ bar⁻¹, from about 3200 to about 16000 L m⁻² h⁻¹ bar⁻¹, from about 4800 to about 16000 L m⁻² h⁻¹ bar⁻¹, from about 6000 to about 16000 L m⁻² h⁻¹ bar⁻¹, or from about 10000 to about 16000 L m⁻² h⁻¹ bar⁻¹.

The nanofiltration membranes may further include a porous substrate, wherein a first surface of the silk layer is in contact with a first contact surface of the porous substrate. The porous substrate in the nanofiltration membrane can be an organic polymer support, a hollow fiber support, a metal support, an inorganic support, or an organic-inorganic hybrid support. For example, the porous substrate is formed from a polymer selected from the group consisting of poly(vinylidene fluoride), polysulfone, poly(ether sulfone), poly(ether ketone) (e.g., poly(ether ether ketone), poly(ether ketone ketone), poly(ether ether ketone ketone), poly(ether ketone ether ketone ketone), etc.), polyacrylonitrile, polypropylene, polyester, polytetrafluoroethylene, poly(arylene ether nitrile ketone), polyamide, polyimide, poly(vinyl chloride), polyaniline, polybenzimidazole, poly(methyl methacrylate), poly(2-hydroxyethyl methacrylate), and poly(phthalazione ether nitrile ketone), or a copolymer thereof, a hydrophilic-modified polymer thereof (e.g., hydroxyl-, carboxyl-, amine-, glutaraldehyde-, sulfone-, or acrylic acid-modified polymer thereof), or a blend thereof; an inorganic material selected from the group consisting of alumina, titanium dioxide, molybdenum disulfide, MXene, silica nanoparticles, zeolite nanoparticles, and ceramic; or a carbon material selected from the group consisting of graphene oxide, hydrophilic-modified graphene oxide, and hydrophilic-modified carbon nanotubes, or a combination thereof.

The porous substrate in the nanofiltration membrane can have an average pore diameter in a range from about 20 nm to about 10 μm, from about 20 nm to about 8 μm, from about 20 nm to about 5 μm, from about 20 nm to about 1 μm, from about 20 nm to about 0.8 μm, or from about 20 nm to about 0.6 μm, and/or a thickness in a range from about 1 μm to about 500 μm, from about 1 μm to about 200 μm, from about 10 μm to about 500 μm, from about 10 μm to about 200 μm, from about 20 μm to about 500 μm, from about 20 μm to about 200 μm, from about 50 μm to about 500 μm, from about 50 μm to about 200 μm, from about 100 μm to about 500 μm, or from about 100 μm to about 200 μm.

The nanofiltration membrane may further include a selective layer, wherein a second surface of the silk layer is in contact with a second contact surface of the selective layer and the second surface of the silk layer is opposite the first surface of the silk layer. The selective layer can be formed from poly(ether sulfone), polyester, or polyamide, or a copolymer thereof, a modified polymer thereof, or a blend thereof. The selective layer can have an average pore diameter in a range from about 0.5 nm to about 2 nm, from about 1 nm to about 2 nm, from about 0.5 nm to about 1.5 nm, from about 1 nm to about 1.5 nm, or from about 0.5 nm to about 1 nm, and/or a thickness in a range from about 5 nm to about 1000 nm, from about 5 nm to about 800 nm, from about 5 nm to about 500 nm, from about 5 nm to about 250 nm, from about 5 nm to about 200 nm, from about 5 nm to about 150 nm, from about 5 nm to about 100 nm, from about 5 nm to about 80 nm, from about 5 nm to about 50 nm, from about 10 nm to about 1000 nm, from about 10 nm to about 800 nm, from about 10 nm to about 500 nm, from about 10 nm to about 250 nm, from about 10 nm to about 200 nm, from about 10 nm to about 150 nm, from about 10 nm to about 100 nm, from about 50 nm to about 1000 nm, from about 50 nm to about 800 nm, from about 50 nm to about 500 nm, from about 50 nm to about 250 nm, from about 50 nm to about 200 nm, from about 50 nm to about 150 nm, from about 50 nm to about 100 nm, from about 100 nm to about 1000 nm, from about 100 nm to about 800 nm, from about 100 nm to about 500 nm, from about 100 nm to about 250 nm, or from about 100 nm to about 200 nm.

The nanofiltration membrane ca be neutral in charge, positively charged, or negatively charged, depending on the target ion/contaminant to be removed from contaminated water. For example, the nanofiltration membrane is negatively charged and thereby can enhance the rejection rate against a negatively charged ion, such as sulfate ion. The nanofiltration membrane can have an ion/contaminant rejection rate of at least 90%, at least 95%, at least 97%, or at least 98% against a target ion/contaminant, such as a divalent ion or a multivalent ion, or a combination thereof, for example, a sulfate ion, magnesium ion, or calcium ion, or a combination thereof.

The nanofiltration membrane can have a water permeance of at least 15 L TIT 2 h⁻¹ bar⁻¹, at least 20 L m⁻² h⁻¹ bar⁻¹, at least 25 L m⁻² h⁻¹ bar⁻¹, in a range from about 15 L m⁻² h⁻¹ bar⁻¹ to about 150 L m⁻² h⁻¹ bar⁻¹, from about 20 L m⁻² h⁻¹ bar⁻¹ to about 150 L m⁻² h⁻¹ bar⁻¹, from about 15 L m⁻² h⁻¹ bar⁻¹ to about 100 L m⁻² h⁻¹ bar⁻¹, or from about 20 L m⁻² h⁻¹ bar⁻¹ to about 100 L m⁻² h⁻¹ bar⁻¹. In some forms, the nanofiltration membrane can have a water permeance that is at least 2-fold, at least 3-fold, at least 4-fold, or at least 5-fold of the water permeance of a commercially available nanofiltration membrane, such as DuPont FilmTec™ NF270 and/or DuPont FilmTec™ NF90, when tested under the same condition.

The nanofiltration membrane can be in a variety of forms, depending on the water filtration system in which it is used. For example, the nanofiltration membrane is in the form of a long cylinder, a sheet, or a monolithic.

Water filtration systems incorporating one or more of the nanofiltration membranes are disclosed. For example, the water filtration system is a gravity-driven system and includes one or more gravity-driven membrane modules; each of the membrane modules has one or more the disclosed nanofiltration membrane(s) installed therein for filtering water. For example, the water filtration system is a vacuum-driven system and includes one or more submerged membrane modules; each of the membrane modules has one or more the disclosed nanofiltration membrane(s) inserted therein.

Methods of making the nanofiltration membrane are disclosed. Generally, the method includes: (i) spraying a suspension of the silk nanomaterials onto the first contact surface of the porous substrate to form a silk layer coated porous substrate. Step (i) can be performed using a vacuum-assisted device, such as a nitrogen spray gun. Optionally, the method further includes: (ii) performing an interfacial polymerization reaction to form the selective layer onto the second surface of the silk layer of the silk layer coated porous substrate. In some forms, the methods may further includes (a) preparing the suspension of the silk nanomaterials prior to step (i) and/or (b) heating the silk-layer coated porous substrate at a temperature in a range from about 30° C. to about 60° C. after step (i).

Methods for filtering water using a water filtration system incorporating one or more of the nanofiltration membranes are also disclosed. The water filtration system can be a gravity-driven system or a vacuum-driven system, such as the exemplary systems described below and shown in FIGS. 5 and 6. Generally, the method for filtering water includes feeding water into the water filtration system, such as seawater, surface water, ground water, and/or wastewater. The method can be used to desalinate seawater, treat surface water, treat ground water, soften water, reuse water, treat industrial wastewater, and/or reclaim wastewater. The methods disclosed herein can filter water with high target ion/contaminant rejection rate and/or high water flux.

For example, when a gravity-driven filtration system incorporating the disclosed nanofiltration membrane(s) is used for filtering water, an ion rejection rate of at least 70%, at least 75%, at least 80%, or at least 85% against a target ion, such as a divalent ion or a multivalent ion, or a combination thereof, and/or a water flux of at least 1 L m⁻² h⁻¹, at least 2 L m⁻² h⁻¹, at least 3 L m⁻² h⁻¹, in a range from about 1 L m⁻² h⁻¹ to about 20 L m⁻² h⁻¹, from about 1 L m⁻² h⁻¹ to about 15 L m⁻² h⁻¹, from about 1 L m⁻² h⁻¹ to about 10 L m⁻² h⁻¹, from about 1 L m⁻² h⁻¹ to about 5 L m⁻² h⁻¹, from about 2 L m⁻² h⁻¹ to about 20 L m⁻² h⁻¹, from about 2 L m⁻² h⁻¹ to about 15 L m⁻² h⁻¹, from about 2 L m⁻² h⁻¹ to about 10 L m⁻² h⁻¹, or from about 2 L m⁻² h⁻¹ to about 5 L m⁻² h⁻¹, such as about 4.5 L m⁻² h⁻¹, can be achieved.

For example, when a vacuum-driven filtration system incorporating the disclosed nanofiltration membrane(s) is used for filtering water, an ion rejection rate of at least 90%, at least 92%, at least 95%, or at least 96% against a target ion, such as a divalent ion or a multivalent ion, or a combination thereof, and/or a water flux of at least 30 L m⁻² h⁻¹, at least 35 L m⁻² h⁻¹, in a range from about 30 L m⁻² h⁻¹ to about 200 L m⁻² h⁻¹, from about 30 L m⁻² h⁻¹ to about 150 L m⁻² h⁻¹, from about 30 L m⁻² h⁻¹ to about 100 L m⁻² h⁻¹, from about 30 L m⁻² h⁻¹ to about 80 L m⁻² h⁻¹, or from about 30 L m⁻² h⁻¹ to about 50 L m⁻² h⁻¹, such as about 38 L m⁻² h⁻¹, can be achieved.

### BRIEF DESCRIPTION OF THE DRAWINGS

FIG. 1A is a schematic showing the SNFs preparation protocol. FIG. 1B is a transmission electron microscope (TEM) image of SNFs.

FIG. 2 is a schematic showing the process of depositing a SNFs interlayer on a porous substrate.

FIG. 3A is a schematic showing the interlayer polymerization process for constructing NFM. FIG. 3B is a schematic showing the morphology of the SNFs interlayer and polyamide layer.

FIGS. 4A-4C are scanning electron microcopy images of PVDF substrate (FIG. 4A), NFM-2 (FIG. 4B), and NFM-5 (FIG. 4C).

FIG. 5 is a schematic showing the structure of an exemplary gravity-driven filtration system incorporating the nanofiltration membrane.

FIG. 6 is a schematic showing the structure of an exemplary vacuum-driven filtration system incorporating the nanofiltration membrane.

### DETAILED DESCRIPTION OF THE INVENTION

### I. Nanofiltration Membranes

Described are nanofiltration membranes for filtering water with high performance, such as improved water permeance and/or high ion removal rate. The high-performance nanofiltration membranes disclosed herein can supply water, such as safe drinking water, with high productivity and high removal efficiency against a wide spectrum of contaminants, such as sulfate, magnesium, calcium, etc. The disclosed nanofiltration membranes can be used in a variety of applications, such as seawater desalination pretreatment, surface water treatment, ground water treatment, water softening, water reuse, and industrial wastewater treatment and wastewater reclamation. The nanofiltration membrane contains a silk layer, which is formed by from silk nanomaterials, such as silk nanofibers. Optionally, the nanofiltration membrane further contains a porous substrate and/or a selective layer. For example, the nanofiltration membrane contains a silk layer and a porous substrate, where a first surface of the silk layer is in contact with a first contact surface of the porous substrate. For example, the nanofiltration membrane contains a silk layer, a porous substrate, and a selective layer, where a first surface of the silk layer is in contact with a first contact surface of the porous substrate, and a second surface of the silk layer is in contact with a second contact surface of the selective layer, wherein the second surface of the silk layer is opposite the first surface of the silk layer.

In some forms, the nanofiltration membranes disclosed herein show improved water permeance and/or high target ion/contaminant removal rate (i.e., an ion/contaminant rejection rate of≥70% against a target ion/contaminant, such as a divalent ion or multivalent ion, for example, sulfate ion, magnesium ion, calcium ion, etc.). For example, the nanofiltration membranes disclosed herein show a water permeance that is at least 2-fold, at least 3-fold, at least 4-fold, or at least 5-fold of the water permeance of a commercially available nanofiltration membrane, such as DuPont FilmTec™ NF270 and/or DuPont FilmTec™ NF90, when tested under the same condition. Such greatly improved water permeance can result in up to a magnitude lower energy consumption in water filtration applications, such as those listed above. The term “tested under the same condition” refers to a test of the water permeance of nanofiltration membranes that is performed using the same device or system, same pressure, same temperature, same velocity, same water source, etc. Without being bound to any theories, it is believed that the silk nanomaterials forming the silk layer have material properties (described below) that allow for fast water transport rate and enhance the formation of the nanofiltration membranes, and thereby improve the water permeance of the nanofiltration membranes disclosed herein.

Further, the substrates used in the nanofiltration membranes is typically highly porous microfiltration substrates. When the substrate is incorporated in the nanofiltration membranes, the silk layer formed by silk nanomaterials (such as silk fibers) is not primarily used to induce a gutter effect (i.e., re-direct water transport). In contrast, the silk layer serves the following roles: (1) maintaining mechanical stability: (2) compatibility with polyamide chemistry; and (3) inducing favorable membrane formation conditions. Regarding point (1), due to the much larger surface pore size of microfiltration substrate compared to that for conventional substrate (e.g., ultrafiltration substrate), the selective layer (such as a polyamide rejection layer) spends over a larger distance, which requires a material of sufficient mechanical stability. The silk layer formed by silk nanomaterials (such as silk fibers) offer excellent mechanical strength and ductility to support the selective layer. Regarding point (2), the silk nanomaterials (such as silk fibers) forming the silk layer have similar chemistry to a polyamide rejection layer, i.e., both materials have amide functional groups, which ensures good compatibility between the two materials and allows the composite membrane to maintain high selectivity. Regarding point (3), the silk layer formed by silk fibers serves as a medium to facilitate/improve the formation of the selective layer (such as a polyamide rejection layer). These features distinguish the nanofiltration membranes disclosed herein from those known in the art.

For example, WO2016/159500 by Chan Hum Park, et al. used silk fibres for dialysis filter, which is structurally and functionally different from the nanofiltration membranes disclosed herein. A dialysis filter allows small molecules (Urea (60 Dalton), calcium (40 Dalton), and phosphorus (30 Dalton), creatinine (113 Dalton), glucose (180 Dalton), and uric acid (168 Dalton)) to pass the filter while retaining large-molecular entities such as proteins and blood cells. In WO2016/159500, silk fibers were used for its bio-compatibility and were incorporated in the primary rejection materials for dialysis filter. In contrast, the nanofiltration membranes disclosed herein retain much smaller molecules of several hundred Dalton. The rejection layer of the disclosed nanofiltration membranes is formed by a polymer, not silk nanomaterials, on a surface of a silk layer. Thus, the silk layer acts as a medium to facilitate/improve the formation of the rejection layer.

For example, Zhe Yang, et al., Environ. Sci. Technol. 2020, 54, 24, 15563-15583 (“Yang”) discloses a general interlayered membrane structure without any silk materials. Yang re-directs water transport through the interlayer (referred as the gutter effect in Yang), which could only improve membrane water permeance for nanofiltration membranes supported on low-porosity substrates (e.g., surface porosity <10%). Such a “re-direct” structure (i.e., gutter effect) could not work with highly porous substrates, such as the substrates used in the nanofiltration membranes disclosed herein.

A. Silk Layer

The disclosed nanofiltration membrane contains a silk layer. The silk layer is formed from silk nanomaterials, such as silk nanofibers. The silk nanomaterials forming the silk layer are nontoxic and biodegradable, which are advantageous for use in water filtration applications.

Silk nanomaterials have material properties that are advantages for water filtration. For example, silk nanofibers (SNFs) are a type of natural protein polymers. SNFs maintain the excellent proprieties of nature silks. They are amphoteric and have abundant surface charges because of the intrinsic structure of polypeptide chains, which can form strong electrostatic force with charged polymers. Additionally, the (3-sheets structure in SNFs endows them with excellent stability and mechanical strength. Therefore, SNFs can be used to improve the mechanical property of other materials in the form of a composite structure. For example, without being bound to any theories, it is believed that these advantageous properties of the silk nanomaterials forming the silk layer allow for fast water transport rate and enhance the formation of the nanofiltration membranes, and thereby improve the water permeance of the nanofiltration membranes disclosed herein.

Typically, the silk layer of the nanofiltration membrane has a transport rate in a range from about 160 to about 16000 L m⁻² h⁻¹ bar⁻¹, from about 500 to about 16000 L m⁻² h⁻¹ bar⁻¹, from about 1000 to about 16000 L m⁻² h⁻¹ bar⁻¹, from about 1600 to about 16000 L m⁻² h⁻¹ bar⁻¹, from about 3200 to about 16000 L m⁻² h⁻¹ bar⁻¹, from about 4800 to about 16000 L m⁻² h⁻¹ bar⁻¹, from about 6000 to about 16000 L m⁻² h⁻¹ bar⁻¹, or from about 10000 to about 16000 L m⁻² h⁻¹ bar⁻¹. The transport rate of the silk layer can be determined using known method, such as a pressure-driven filtration method described below.

Silk nanomaterials for forming the silk layer of the disclosed nanofiltration membranes can be extracted from a variety of sources, such as silkworms (e.g., Bombyx mori and related species); spiders (e.g., Nephila clavipes); genetically engineered bacteria, yeast mammalian cells, insect cells, and transgenic plants and animals; cultured cells from silkworms or spiders; native silks; cloned full or partial sequences of native silks; synthetic genes encoding silk or silk-like sequences. For example, SNFs suitable for forming the silk layer of the disclosed nanofiltration membranes can be directly extracted from silkworm silks via simple physical-chemical processing.

Raw silk materials obtained from the above-described sources, such as Bombyx mori silkworms, are coated with a glue-like protein, i.e. sericin, which typically is removed from the raw silk materials to form degummed silk materials. The degummed silk materials are then hydrolyzed to break the degummed silk into silk nanomaterials that form the silk layer. Thus, the silk nanomaterials forming the silk layer are partially hydrolyzed materials from the degummed silk, which are known as fibroin.

The silk nanomaterials forming the silk layer can be in a variety of forms. For example, although the silk nanomaterials forming the silk layer are preferably in the form of fibers, such as nanofibers, they can be in other forms, such as foams, meshes, or sponges, or a combination thereof. The silk nanomaterials in the silk layer can be in a single form, such as fibers, or more than one form. For example, a first portion of the silk nanomaterials in the silk layer is in the form of fibers and a second portion of the silk nanomaterials in the same silk layer is in the form of meshes.

When the silk nanomaterials forming the silk layer are silk fibers, these silk fibers can have an average diameter in a range from about 10 μm to about 60 μm, from about 10 μm to about 50 μm, from about 10 μm to about 40 μm, from about 10 μm to about 30 μm, or from about 20 μm to about 40 μm.

In some forms, the silk layer may further contain a collogen or a polymer, or a combination thereof. When a collogen is contained in the silk layer, the collogen can be in a variety of forms, such as fibers, foams, meshes, or sponges, or a combination thereof. Polymers that are suitable for use in the silk layer can be a biodegradable polymer or a non-biodegradable polymer, or a combination thereof. Exemplary biodegradable polymers that are suitable for use in the silk layer include, but are not limited to, cellulose, cotton, gelatin, poly lactide, poly glycolic, poly(lactide-co-glycollide), poly(caprolo actone), polyamides, polyanhydrides, polyaminoacids, poly(ortho esters), polyacetals, proteins, degradable polyurethanes, polysaccharides, polycyanoacrylates, glycosaminoglycans (e.g., chrondroitin Sulfate, heparin, etc.), polysaccharides-native, reprocessed or genetically engineered versions (e.g., hyaluronic acid, alginates, Xanthans, pectin, chitosan, chitin, and the like, elastin-native, reprocessed or genetically engineered and chemical versions, and collagens-native, reprocessed or genetically engineered versions, and a combination thereof. Exemplary non-biodegradable polymers that are suitable for use in the silk layer include, but are not limited to, polyamide, polyester, polystyrene, polypropylene, polyacrylate, polyvinyl, polycarbonate, polytetrafluorethylene, and nitrocellulose material, and a combination thereof.

Typically, the silk nanomaterials have a weight loading in a range from about 40 to about 150 μg/cm² in the nanofiltration membrane, such as a weight loading of about 41 μg/cm², about 61 μg/cm², or about 102 μg/cm² in the nanofiltration membrane.

The silk layer of the nanofiltration membrane is porous. Typically, the pores in the silk layer have an average pore diameter in a range from about 10 nm to about 1.5 μm, from about 20 nm to about 1.2 μm, from about 20 nm to about 0.8 μm, from about 20 nm to about 0.6 μm, from about 50 nm to about 1.5 μm, from about 50 nm to about 1.0 μm, from about 50 nm to about 0.8 μm, from about 0.1 μm to about 1.5 μm, from about 0.2 μm to about 1.5 μm, or from 0.5 μm to about 1.5 μm.

Typically, the silk layer of the nanofiltration membrane has a thickness in a range from about 100 nm to about 100 μm, from about 1 μm to about 100 μm, from about 10 μm to about 100 μm, from about 10 μm to about 80 μm, from about 20 μm to about 100 μm, or from about 20 μm to about 80 μm.

B. Porous Substrate

The disclosed nanofiltration membranes may contain a porous substrate. The porous substrate is highly porous, such as a highly porous microfiltration substrate. Typically, the porous substrate has a surface porosity of at least 10%, which can be measured using a method known in the art, such as mercury porosimetry, helium pycnometry, image analysis, and/or water absorption. For example, the porous substrate of the nanofiltration membrane has a surface porosity ranging from 10% to 90%, from 10% to 80%, from 10% to 70%, from 10% to 60%, from 10% to 50%, such as 10%, about 20%, about 30%, about 40%, about 50%, or more than 50%. When a porous substrate is included in the nanofiltration membrane, a first surface of the silk layer is in contact with a first contact surface of the porous substrate.

The porous substrate included in the nanofiltration membrane can be an organic polymer support, a hollow fiber support, a metal support, an inorganic support, or an organic-inorganic hybrid support. Materials that are suitable for forming the porous substrate of the nanofiltration membrane include, but are not limited to a polymer, an inorganic material, a metal-organic framework, a carbon material, or a metal or sintered metal, or a combination thereof.

Examples of polymers that are suitable for forming the porous substrate include, but are not limited to, poly(vinylidene fluoride), polysulfone, poly(ether sulfone), poly(ether ketone) (e.g., poly(ether ether ketone), poly(ether ketone ketone), poly(ether ether ketone ketone), poly(ether ketone ether ketone ketone), etc.), polyacrylonitrile, polypropylene, polyester, polytetrafluoroethylene, poly(arylene ether nitrile ketone), polyamide, polyimide, poly(vinyl chloride), polyaniline, polybenzimidazole, poly(methyl methacrylate), poly(2-hydroxyethyl methacrylate), poly(phthalazione ether nitrile ketone), a copolymer thereof, and a hydrophilic-modified polymer thereof (e.g., hydroxyl-, carboxyl-, amine-, glutaraldehyde-, sulfone-, or acrylic acid-modified polymer thereof, such as a sulfonated poly(ether ether ketone)), and a blend thereof.

Examples of inorganic materials that are suitable for forming the porous substrate include, but are not limited to, alumina (Al₂O₃), titanium dioxide (TiO₂), molybdenum disulfide, MXene, silica (SiO₂, such as silica nanoparticles), zeolite nanoparticles, and ceramic, and a combination thereof.

Examples of carbon materials that are suitable for forming the porous substrate include, but are not limited to, graphene oxide, hydrophilic-modified graphene oxide (such as graphene oxide modified with hydroxyl, carboxyl, amine, glutaraldehyde, sulfone, and/or acrylic acid), and hydrophilic-modified carbon nanotubes (such as carbon nanotubes modified with hydroxyl, carboxyl, amine, glutaraldehyde, sulfone, and/or acrylic acid), and a combination thereof.

Typically, the porous substrate has an average pore diameter in a range from about 20 nm to about 10 μm, such as from about 20 nm to about 8 μm, from about 20 nm to about 5 μm, from about 20 nm to about 1 μm, from about 20 nm to about 0.8 μm, or from about 20 nm to about 0.6 μm. In some forms, the porous substrate has an average pore diameter of larger than 100 nm, such as from >100 nm to about 10 μm or from >100 nm to about 1 μm.

The substrate can have a thickness in a range from about 1 μm to about 500 μm, from about 1 μm to about 200 μm, from about 10 μm to about 500 μm, from about 10 μm to about 200 μm, from about 20 μm to about 500 μm, from about 20 μm to about 200 μm, from about 50 μm to about 500 μm, from about 50 μm to about 200 μm, from about 100 μm to about 500 μm, or from about 100 μm to about 200 μm.

C. Selective Layer

The disclosed nanofiltration membranes may contain a selective layer. When a selective layer is included in the nanofiltration membrane, a second surface of the silk layer is in contact with a second contact surface of the porous substrate. For example, the nanofiltration membrane contains a silk layer, a porous substrate, and a selective layer, where a first surface of the silk layer is in contact with a first contact surface of the porous substrate, and a second surface of the silk layer is in contact with a second contact surface of the selective layer, wherein the second surface of the silk layer is opposite the first surface of the silk layer.

Typically, the selective layer is formed from a polymer, such as poly(ether sulfone), polyester, or polyamide, a copolymer thereof, a modified polymer thereof, or a blend thereof. For example, the selective layer is formed from polyamide using interfacial polymerization reaction.

The selective layer is also porous. Typically, the pores in the selective layer have an average pore diameter in a range from about 0.5 nm to about 2 nm, from about 1 nm to about 2 nm, from about 0.5 nm to about 1.5 nm, from about 1 nm to about 1.5 nm, or from about 0.5 nm to about 1 nm.

The selective layer can have a thickness in a range from about 5 nm to about 1000 nm, from about 5 nm to about 800 nm, from about 5 nm to about 500 nm, from about 5 nm to about 250 nm, from about 5 nm to about 200 nm, from about 5 nm to about 150 nm, from about 5 nm to about 100 nm, from about 5 nm to about 80 nm, from about 5 nm to about 50 nm, from about 10 nm to about 1000 nm, from about 10 nm to about 800 nm, from about 10 nm to about 500 nm, from about 10 nm to about 250 nm, from about 10 nm to about 200 nm, from about 10 nm to about 150 nm, from about 10 nm to about 100 nm, from about 50 nm to about 1000 nm, from about 50 nm to about 800 nm, from about 50 nm to about 500 nm, from about 50 nm to about 250 nm, from about 50 nm to about 200 nm, from about 50 nm to about 150 nm, from about 50 nm to about 100 nm, from about 100 nm to about 1000 nm, from about 100 nm to about 800 nm, from about 100 nm to about 500 nm, from about 100 nm to about 250 nm, or from about 100 nm to about 200 nm.

D. Exemplary Nanofiltration Membranes

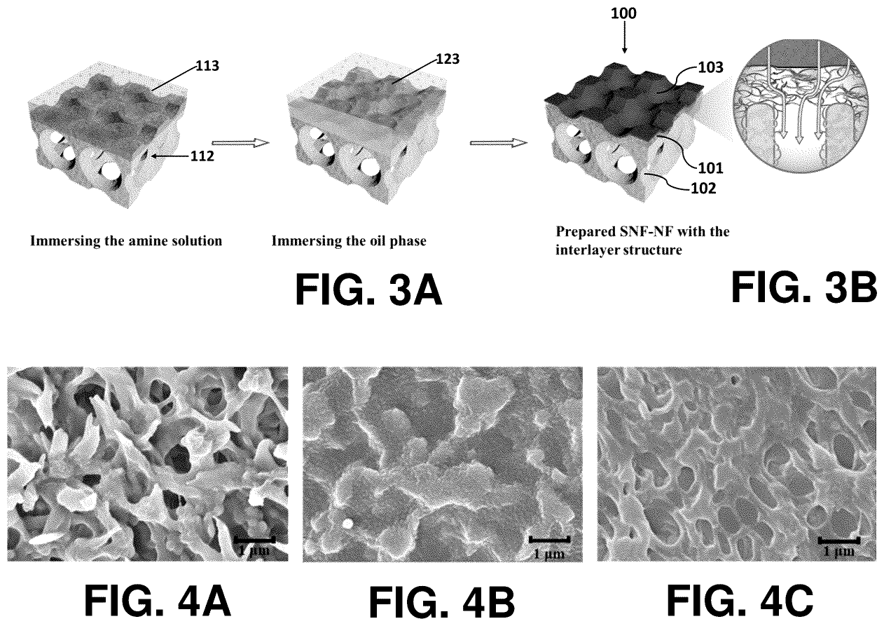

An exemplary nanofiltration membrane is illustrated in FIG. 3A. As shown in FIG. 3A, the nanofiltration membrane 100 includes a silk layer 101, a porous substrate 102, and a selective layer 103. The silk layer 101 is sandwiched between the porous substrate 102 and the selective layer 103. A first surface (not visible in FIG. 3A) of the silk layer 101 contacts a first contact surface of the porous substrate 102 (not visible in FIG. 3A). A second surface (not visible in FIG. 3A) of the silk layer 101, which is the opposite of the first surface of the silk layer, contacts a second contact surface (not visible in FIG. 3A) of the selective layer 103.

E. Properties

The disclosed nanofiltration membrane has improved properties for filtering water. For example, the nanofiltration membranes disclosed herein show improved water permeance and/or high target ion removal rate (i.e. an ion rejection rate of≥70% against a target ion, such as a divalent ion or multivalent ion, for example, sulfate ion, magnesium ion, calcium ion, etc.).

In some forms, the nanofiltration membranes can have a water permeance of at least 15 L m⁻² h⁻¹ bar⁻¹, at least 20 L m⁻² h⁻¹ bar⁻¹, at least 25 L m⁻² h⁻¹ bar⁻¹, in a range from about 15 L m⁻² h⁻¹ bar⁻¹ to about 150 L m⁻² h⁻¹ bar⁻¹ from about 20 L m⁻² h⁻¹ bar⁻¹ to about 150 L m⁻² h⁻¹ bar⁻¹, from about 15 L m⁻² h⁻¹ bar⁻¹ to about 100 L m⁻² h⁻¹ bar⁻¹, or from about 20 L m⁻² h⁻¹ bar⁻¹ to about 100 L m⁻² h⁻¹ bar⁻¹.

In some forms, the nanofiltration membranes disclosed herein have a water permeance that is at least 2-fold, at least 3-fold, at least 4-fold, or at least 5-fold of the water permeance of a commercially available nanofiltration membrane, such as DuPont FilmTec™ NF270 and/or DuPont FilmTec™ NF90, when tested under the same condition. Such greatly improved water permeance can result in up to a magnitude lower energy consumption in water filtration applications, such as those listed above. Without being bound to any theories, it is believed that the silk nanomaterials forming the silk layer have material properties (described below) that allow for fast water transport rate and enhance the formation of the nanofiltration membranes, and thereby improve the water permeance of the nanofiltration membranes disclosed herein. For example, the silk layer of the nanofiltration membrane has a transport rate of at least 160 L m⁻² h⁻¹ bar⁻¹, such as in a range from about 160 to about 16000 L m⁻² h⁻¹ bar⁻¹, from about 500 to about 16000 L m⁻² h⁻¹ bar⁻¹, from about 1000 to about 16000 L m⁻² h⁻¹ bar⁻¹, from about 1600 to about 16000 L m⁻² h⁻¹ bar⁻¹, from about 3200 to about 16000 L m⁻² h⁻¹ bar⁻¹, from about 4800 to about 16000 L m⁻² h⁻¹ bar⁻¹, from about 6000 to about 16000 L m⁻² h⁻¹ bar⁻¹, or from about 10000 to about 16000 L m⁻² h⁻¹ bar⁻¹, determined using a pressure-driven filtration method. For example, the transport rate of the silk layer is determined using a pressure-driven filtration system for measuring the water flux of a substrate alone (such as a PVDF substrate alone) and the substrate coated with a silk layer loaded at different amount (such as amounts ranging from 41 to 102 μg/cm²), following which, a resistance-in-series model (1/A_{NFM}=1/A_{PVDF}+1/A_{silk interlayer}, where A is water permeance) is applied to calculate the transport rate of the silk layer.

In some forms, the nanofiltration membranes can have an ion/contaminant rejection rate of at least 90%, at least 95%, at least 97%, or at least 98% against a target ion/contaminant. The target ion/contaminant rejected by the nanofiltration membranes can be a divalent ion, a multivalent ion, a heavy metal, or an organic micropollutant, or a combination thereof. For example, the target ion rejected by the nanofiltration membrane is a divalent ion, such as a sulfate ion, magnesium ion, calcium ion.

The nanofiltration membrane can be positively or negatively charged, or charge-neutral, depending on the target ions, solutes, and/or contaminants being removed from the water. For example, the nanofiltration membrane is negatively charged and thereby enhances rejection of negatively charged ions, such as SO₄²⁻. The charges of the nanofiltration membranes, i.e., positively charged, negatively charged, or neural, can be prepared by using monomers having the desired charges to form the substrate and/or selective layer, or by surface modifications of the substrate, the silk layer, and/or the selective layer to introduce desired charges, or a combination thereof.

Each of the layers in the nanofiltration membrane can have any suitable shape as long as they can be stacked to form the nanofiltration membrane. The nanofiltration membrane may be configured as (1) long cylinders such as tubulars or spiral wound, (2) sheets such as rolled or flat sheets, or (3) monolithic, such that it can be incorporated in a water filtration system. Nanofiltration membranes in the form of flat sheets may be used to form a plate, a frame, and/or a spiral wound. When the nanofiltration membranes are in the form of flat sheets, the flat sheets may be circular, square, or rectangular. For example, the nanofiltration membrane is configured as a flat sheet for incorporation into a water filtration system, such as a gravity-driven or vacuum-driven water filtration system.

### II. Systems Incorporating the Nanofiltration Membranes

The nanofiltration membranes disclosed herein can be incorporated in a water filtration system, such as a gravity-driven system or a vacuum-driven system. For example, a single nanofiltration membrane or more than one nanofiltration membrane is incorporated in the membrane unit of a water filtration system. When more than one nanofiltration membrane is incorporated in the water filtration system, each of the nanofiltration membranes may be in the same form or different forms. For example, two or more nanofiltration membranes are incorporated in the water filtration system, where one or more nanofiltration membrane(s) is(are) in a first form, such as flat or rolled sheet(s) and one or more nanofiltration membrane(s) is(are) in a second form that is different from the first form, such as tubular(s) or module(s). The more than one nanofiltration membrane in the membrane unit of the water filtration system can be arranged horizontally or vertically.

For example, the membrane unit of a water filtration system can include a flat-sheet nanofiltration membrane and/or a tubular nanofiltration membrane, such as that described in Chong, et al., Journal of Membrane Science, 587(117161):1-12, 2019.

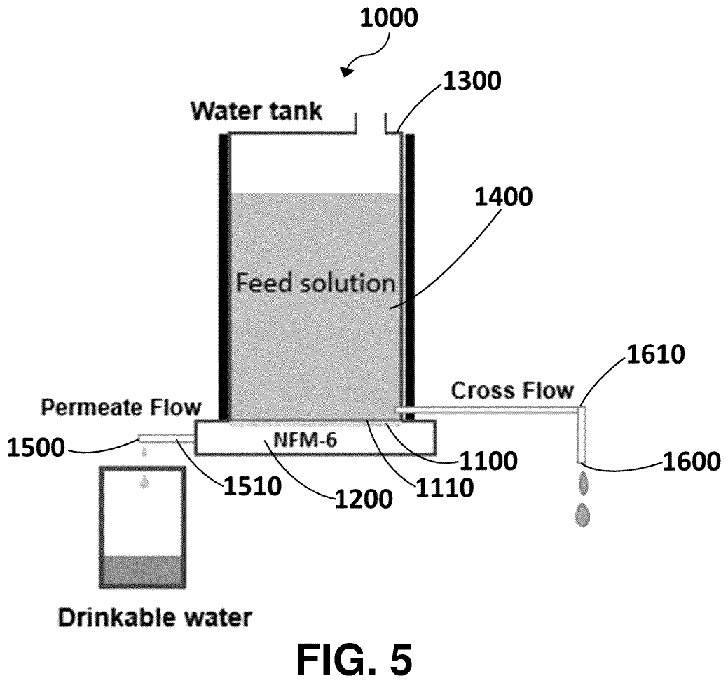

In some forms, the nanofiltration membranes disclosed herein can be incorporated in a gravity-driven water filtration system. An exemplary gravity-driven system incorporating the nanofiltration membrane is illustrated in FIG. 5. As shown in FIG. 5, the gravity-driven filtration system 1000 includes a gravity-driven membrane module 1200 which contains a nanofiltration membrane 1100 installed therein, a water tank 1300 for holding a feed solution 1400, a first outlet 1500, and a second outlet 1600. The gravity-driven membrane module 1200 is located on the bottom of the water tank and in fluid communication with the water tank. The nanofiltration membrane 1100 is positioned in the membrane module 1200 such that it is in contact with the feed solution 1400. The first outlet 1500 is connected to the membrane module 1200 via a first conduit 1510, and thereby is in fluid communication with the membrane module 1200. A hydraulic pressure provided by the water head can drive the feed solution 1400 to pass through the nanofiltration membrane 1100 and produce permeates (e.g., purified liquid, such as drinkable water) in the membrane module 1200. The permeates (e.g., purified liquid, such as drinkable water) flows from the membrane module 1200, through the first conduit 1510, and exits from the first outlet 1500. The second outlet 1600 is connected to the water tank 1300 optionally via a second conduit 1610, and thereby is in fluid communication with the water tank 1300. The incorporation of the second outlet 1600 and optionally the second conduit 1610 is to allow release of the feed solution 1400 from the water tank 1300 (which is referred to as a “cross flow”) to mitigate the concentration polarization effect and/or membrane fouling.

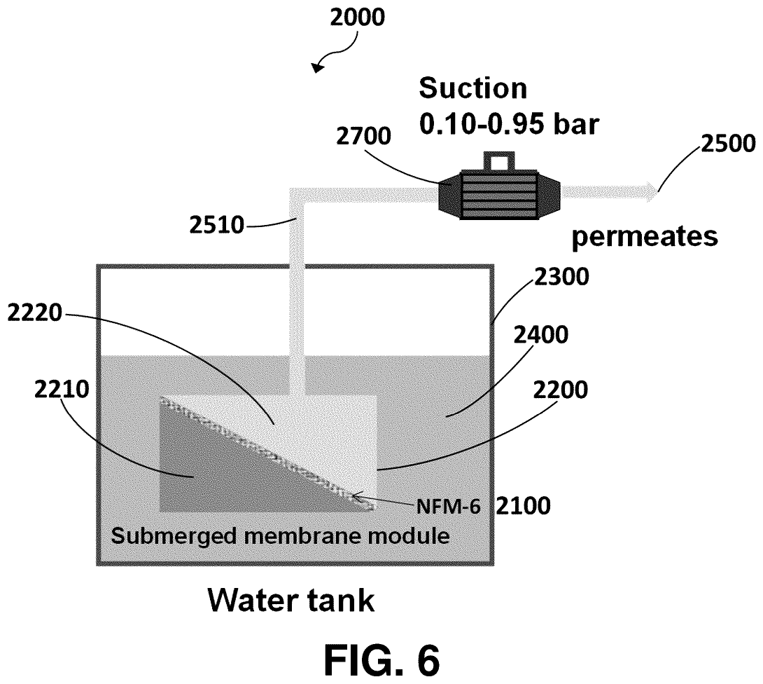

In some forms, the nanofiltration membranes disclosed herein can be incorporated in a vacuum-driven water filtration system. An exemplary vacuum-driven filtration system incorporating the nanofiltration membrane is illustrated in FIG. 6. As shown in FIG. 6, the vacuum-driven filtration system 2000 includes a submerged membrane module 2200 which contains a nanofiltration membrane 2100 inserted therein, a water tank 2300 for holding a feed solution 2400, and an outlet 2500. The membrane module 2200 is placed inside the water tank 2300, such that when the feed solution 2400 is fed into the water tank, the membrane module 2200 with the nanofiltration membrane 2100 inserted therein is immersed in the feed solution. The outlet 2500 is connected to the membrane module 2200 via a conduit 2510, and thereby is in fluid communication with the membrane module 2200. A vacuum pressure (e.g., 0.1˜0.95 bar) provided by a pump 2700 connected to the conduit 2510 can suck the feed solution 2400 into a first compartment 2210 of the membrane module 2200, through the nanofiltration membrane 2100, and produce permeates (e.g., purified liquid, such as drinkable water) in a second compartment 2220 of the membrane module. Driven by the vacuum pressure, the permeates (e.g., drinkable water) flows from the second compartment 2220, through the conduit 2510, and exits from the outlet 2500.

### III. Methods of Making the Nanofiltration Membranes

Methods for making the disclosed nanofiltration membranes are also described. Generally, the method includes (i) spraying a suspension of silk nanomaterials onto a surface of the porous substrate to form a silk layer coated porous substrate.

In some forms, the nanofiltration membrane contains three layers: a silk layer, a porous substrate, and a selective layer, where the silk layer is sandwiched in between the porous substrate and the selective layer. In these forms, the method for making the nanofiltration membrane includes (i) spraying a suspension of silk nanomaterials onto a surface of the porous substrate to form a silk layer coated porous substrate and (ii) performing an interfacial polymerization reaction to form the selective layer onto the second surface of the silk layer of the silk layer coated porous substrate.

A. Spraying Suspension of Silk Nanomaterials onto Porous Substrate

The suspension of silk nanomaterials can be sprayed onto the surface of the porous substrate by any suitable method known in the art. Preferably, the suspension of silk nanomaterials is sprayed onto the surface of the porous substrate using a vacuum-assisted device, such as using a nitrogen spray gun.

Typically, the suspension of silk nanomaterials being sprayed onto the surface of the porous substrate contains the silk nanomaterials at a volume loading in a range from about 0.01 mL cm⁻² to about 20 mL cm⁻², from about 0.05 mL cm⁻² to about 20 mL cm⁻², from about 0.1 mL cm⁻² to about 20 mL cm⁻², from about 0.2 mL cm⁻² to about 20 mL cm⁻², from about 0.01 mL cm⁻² to about 10 mL cm⁻², from about 0.05 mL cm⁻² to about 10 mL cm⁻², from about 0.1 mL cm⁻² to about 10 mL cm⁻², from about 0.2 mL cm⁻² to about 10 mL cm⁻², from about 0.2 mL cm⁻² to about 8 mL cm⁻², from about 0.2 mL cm⁻² to about 5 mL cm⁻², from about 0.2 mL cm⁻² to about 2 mL cm⁻², or from about 0.2 mL cm⁻² to about 1 mL cm⁻², such as in a range from about 0.01 mL cm⁻² to about 20 mL cm⁻², from about 0.2 mL cm⁻² to about 10 mL cm⁻², about 0.3 mL cm⁻², about 0.5 mL cm⁻², or about 0.8 mL cm⁻². The desired volume loading of silk nanomaterials in the suspension being sprayed onto the surface of the porous substrate can be adjusted using water dilution.

1. Preparing Suspension of Silk Nanomaterials

The method may further include a step of preparing a suspension of the silk nanomaterials, prior to step (i) spraying the suspension of the silk nanomaterials onto a surface of a porous substrate. The silk nanomaterials suspension preparation can follow any suitable methods known in the art, such as that described in Rockwood, et al., Nature Protocols, 6(10):1612-1631, 2011. For example, the suspension preparation step may include (1) boiling a raw silk material in a base solution comprising a base to form a degummed silk material, optionally wherein the base has a concentration in a range from about 0.1 wt % to about 10 wt %, from about 0.5 wt % to about 10 wt %, from about 1 wt % to about 10 wt %, from about 2 wt % to about 10 wt %, from about 0.1 wt % to about 5 wt %, from about 0.1 wt % to about 1 wt %, or from about 2 wt % to about 5 wt % of the base solution, such as about 0.5 wt % of sodium carbonate; (2) mixing the degummed silk material with an acid to form a mixture, optionally wherein the acid has a concentration in a range from about 10 wt % to about 70 wt %, from about 20 wt % to about 60 wt %, or from about 30 wt % to about 50 wt %, such as about 40 wt % sulfuric acid; (3) heating the mixture at a temperature in a range from about 30° C. to about 80° C., from about 40° C. to about 80° C., from about 50° C. to about 80° C., or from about 50° C. to about 70° C., such as about 60° C., for a time period in a range from about 30 mins to about 300 mins to form a suspension of the silk nanomaterials. Optionally, the silk nanomaterials in the suspension are partially hydrolyzed.

The raw silk material being boiled in step (1) can be silk extracted from a variety of sources, such as any one of those described above, before any chemical treatment. The base suitable for use in the base solution during step (1) boiling the raw silk material, can be sodium carbonate, sodium bicarbonate, potassium carbonate, or potassium bicarbonate, or a combination thereof.

The acid suitable for use in mixing with the degummed silk material during step (2) can be sulfuric acid, nitric acid, hydrochloric acid, citric acid, and acetic acid, and a combination thereof.

In some forms, the suspension preparation step may further include (4) diluting the suspension with water, (5) sonicating the suspension, and/or (6) removing fibrillated materials from the suspension, after step (3) heating a mixture of a degummed silk material with acid to form a suspension of the silk nanomaterials.

In some forms, the suspension preparation step may further include (7) adjusting the pH of the suspension to a pH in a range from 7 to 11, such as about pH 10, after step (3) heating a mixture of a degummed silk material with acid to form a suspension of the silk nanomaterials. When the suspension preparation step includes the additional steps (4), (5), and/or (6) described above, the pH adjustment step (7) may be performed as the last step in preparing the suspension of silk nanomaterials. For example, the suspension preparation step includes an additional step (4) diluting the suspension with water, and the pH adjustment step (7) is performed after step (4). For example, the suspension preparation step includes an additional step (5) sonicating the suspension, and the pH adjustment step (7) is performed after step (5). For example, the suspension preparation step includes an additional step (6) removing fibrillated materials from the suspension, and the pH adjustment step (7) is performed after step (6). For example, the suspension preparation step includes additional steps (4)-(6), and the pH adjustment step (7) is performed after step (6).

2. Heating Silk Layer Coated Porous Substrate

The method may further include a step of heating the silk layer coated porous substrate at a suitable temperature for a sufficient period of time to stabilize the silk layer, after step (i) spraying the suspension of the silk nanomaterials onto a surface of a porous substrate.

For example, after the suspension of the silk nanomaterials is sprayed onto a surface of the porous substrate, the silk layer coated porous substrate is heated at a temperature in a range from about 30° C. to about 60° C., from about 40° C. to about 50° C., such as about 45° C., for a time period in a range from about 1 min to about 20 mins, from about 2 mins to about 20 mins, from about 5 mins to about 20 mins, from about 5 mins to about 15 mins, or from about 2 mins to about 10 mins, such as about 10 mins. The heating step can stabilize the silk layer formed on the surface of the porous substrate.

B. Performing Interfacial Polymerization

When the nanofiltration membrane contains three layers: a silk layer, a porous substrate, and a selective layer, where the silk layer is sandwiched in between the porous substrate and the selective layer, the method for making the nanofiltration membrane includes (i) spraying a suspension of silk nanomaterials onto a surface of the porous substrate to form a silk layer coated porous substrate; and (ii) performing an interfacial polymerization reaction to form the selective layer onto the second surface of the silk layer of the silk layer coated porous substrate. For example, the nanofiltration membrane is prepared by vacuum-assisted spraying and interfacial polymerization reaction.

In some forms, the interfacial polymerization reaction is performed between an amine in an aqueous solution and an acid chloride in an organic solution. Generally, interfacial polymerization reaction between an amine and an acid chloride to form the selective layer of the nanofiltration membrane can be performed at room temperature (i.e. 20 to 25° C. at 1 atm) for a time period in a range from about 10 seconds to about 5 mins, from about 20 seconds to about 4 mins, from about 30 seconds to about 4 mins, from about 30 seconds to about 3 mins, from about 30 seconds to about 2 mins, or from 30 seconds to about 1 min, such as about 30 seconds or 60 seconds.

When the interfacial polymerization reaction is performed between an amine in an aqueous solution and an acid chloride in an organic solution, additional steps may be performed prior to step (ii) performing the interfacial polymerization reaction. For example, the method can further include, after the formation of the silk layer on the porous substrate (or stabilization of the silk layer by heating) and prior to performing the interfacial polymerization reaction: (c) contacting the second surface of the silk layer with an aqueous solution containing an amine to form an amine coated silk layer, optionally wherein the amine has a concentration in a range from about 0.05 wt % to about 5 wt %, from about 0.1 wt % to about 5 wt %, from about 0.1 wt % to about 2 wt %, from about 0.1 wt % to about 1 wt %, such as about 0.1 wt % or about 0.5 wt %; and (d) contacting the amine coated silk layer with an organic solution containing an acid chloride to initiate the interfacial polymerization reaction, optionally wherein the acid chloride has a concentration in a range from about 0.05 wt % to about 1 wt %, from about 0.1 wt % to about 0.5 wt %, or from about 0.1 wt % to about 0.25 wt %, such as about 0.1 wt % or about 0.25 wt %. Once interfacial polymerization reaction is initiated, the reaction can be maintained for any one of the time period described above at room temperature to form the selective layer.

Amines suitable for use in the aqueous solution can be a monoamine or a diamine, such as an aromatic diamine or a cyclic aliphatic diamine. For example, the amine used in the aqueous solution for performing the interfacial polymerization reaction can be meta-phenylene diamine (MPD), ortho-phenylene diamine (OPD), para-phenylene diamine (PPD), piperazine, bipiperidine, m-xylene diamine (MXDA), ethylenediamine, trimethylenediamine, hexamethylenediamine, diethylene triamine (DETA), triethylene tetramine (TETA), methane diamine (MDA), isophoronediamine (IPDA), triethanolamine, polyethyleneimine, methyl diethanolamine, or hydroxyalkylamine, or a combination thereof. In some forms, the amine used in the aqueous solution for performing the interfacial polymerization reaction can be piperazine or ethanediamine, such as piperazine.

Examples of acid chlorides suitable for use in the organic solution include, but are not limited to, monomers having an acyl chloride end-group, trimesoyl chloride (TMC), terephthaloyl chloride, isophthaloyl chloride, cyclohexane-1,3,5-tricarbonyl chloride, 5-isocyanato-isophthaloyl chloride, cyanuric chloride, trimellitoyl chloride, phosphoryl chloride, and glutaraldehyde, and a combination thereof, such as trimesoyl chloride. Organic solvents suitable for use to form the organic solution containing acid chlorides can be hexane, pentane, cyclohexane, heptane, octane, carbon tetrachloride, benzene, xylene, toluene, chloroform, tetrahydrofuran, or isoparaffin, or combinations thereof.

In some forms, the method may further include (e) removing an excess amount of the aqueous solution from the second surface of the silk layer. Step (e) can be performed after step (c) contacting the second surface of the silk layer with an aqueous solution containing an amine and prior to step (d) contacting the amine coated silk layer with an organic solution containing an acid chloride. The excess amount of the aqueous solution can be removed from the silk layer surface by methods known in the art, such as by roller removal.

C. Exemplary Fabrication Method

An exemplary process is illustrated in FIG. 3A. As shown in FIG. 3A, the silk layer (not visible in FIG. 3A) of a silk layer coated porous substrate 112 is soaked in an amine solution 113 and excessive amine solution is subsequently removed from the silk layer surface. Then an organic solution 123 is quickly poured on the amine-soaked silk layer of the silk layer coated porous and the reaction is performed for 30 seconds to 240 second to generate the selective layer.

### IV. Methods of Using the Nanofiltration Membranes

Methods of using the nanofiltration membranes disclosed herein are described. For example, the disclosed nanofiltration membranes can be used for filtering water. The advanced features of the nanofiltration membranes disclosed herein, such as the improved water permeance and high ion rejection against a target ion, allow them to be used in a variety of applications involving filtering water, such as water softening, dye wastewater disposal, wastewater reclamation, drinking water supply, desalination pretreatment. For example, the nanofiltration membranes, when incorporated in water filtration systems, can be used in water filtration applications that target for divalent or multivalent ions removal and/or to decrease the hydraulic operating pressure to increase membrane water flux and/or reduce/prevent fouling issues.

Generally, the method for filtering water using a water filtration system containing one or more of the disclosed nanofiltration membranes includes feeding water into the water filtration system. The water fed into the water filtration system (also referred to herein as “feed water” or “feed solution”) passes through the nanofiltration membrane, driven by a pressure, such as a water head when using a gravity-driven filtration system or a vacuum pressure when using a vacuum-driven filtration system. The water filtration system used in the method can be a gravity-driven water filtration system or a vacuum-driven water filtration system.

The water being fed into the water filtration system (i.e., feed water or feed solution) can be seawater, surface water, ground water, or wastewater, or a combination thereof. The purpose of such a method can be seawater desalination pretreatment, surface water treatment, ground water treatment, water softening, water reuse, industrial wastewater treatment, or wastewater reclamation, or a combination thereof.

In some forms, the water being fed into the water filtration system (i.e., feed water or feed solution), such as a gravity-driven or vacuum-driven system, using the disclosed method can contain the target ion (i.e. ion to be removed), such as sulfate ion, calcium ion, magnesium ion, etc., at a concentration in a range from about 0.1 g/L to about 10 g/L, from about 0.1 g/L to about 5 g/L, from about 0.1 g/L to about 2 g/L, from about 0.1 g/L to about 1 g/L, from about 0.1 g/L to about 0.5 g/L, from about 0.2 g/L to about 10 g/L, from about 0.2 g/L to about 5 g/L, from about 0.2 g/L to about 2 g/L, from about 0.2 g/L to about 1 g/L, or from about 0.2 g/L to about 0.5 g/L, such as about 0.5 g/L. In some forms, the water being fed into the water filtration system using the disclosed method can have an osmotic pressure in a range from about 0.1 bar to about 10 bar, from about 0.1 bar to about 8 bar, from about 0.1 bar to about 6 bar, from 0.1 bar to about 4 bar, from 0.1 bar to about 2 bar, from 0.1 bar to about 1 bar, from about 0.1 bar to about 0.8 bar, from about 0.1 bar to about 0.6 bar, from about 0.1 bar to about 0.4 bar, or from about 0.1 bar to about 0.2 bar, such as about 0.19 bar or about 0.95 bar.

In some forms, the water filtration system used in the method can be a gravity-driven system containing one or more of the nanofiltration membranes disclosed herein. In these forms, the water filtration can be driven by a water head in a range from about 0.5 m to about 50 m, from about 0.5 m to about 30 m, from about 0.5 m to about 20 m, from about 0.5 m to about 10 m, from about 1 m to about 10 m, from about 1 m to about 8 m, from about 1 m to about 6 m, from about 1 m to about 5 m, or from about 1 m to about 3 m, such as about 3 m. When a gravity-driven system is used, the water can be fed into the system with a cross-flow velocity in a range from about 0.1 Lh⁻¹ to about 100 L h⁻¹, from about 0.1 L h⁻¹ to about 80 L h⁻¹, from about 0.1 L h⁻¹ to about 50 L h⁻¹, from about 0.1 L h⁻¹ to about 20 L h⁻¹, from about 0.1 Lh⁻¹ to about 10 L h⁻¹, from about 0.1 L h⁻¹ to about 8 L h⁻¹, from about 0.1 L h⁻¹ to about 6 L h⁻¹, from about 0.1 L h⁻¹ to about 5 L h⁻¹, from about 0.1 L h⁻¹ to about 3 L h⁻¹, from about 0.1 L h⁻¹ to about 2 L h⁻¹, from about 0.1 L h⁻¹ to about 1 L h⁻¹, from about 0.5 L h⁻¹ to about 5 L h⁻¹, from about 0.5 L h⁻¹ to about 3 L h⁻¹, from about 0.5 L h⁻¹ to about 2 L h⁻¹, or from about 0.5 L h⁻¹ to about 1 L h⁻¹, such as about 0.9 L h⁻¹. In some forms, the water filtration system used in the method can be a vacuum-driven system containing one or more of the nanofiltration membranes disclosed herein. In these forms, the water filtration can be performed with a transmembrane pressure in a range from about 0.1 bar to about 10 bar, from about 0.1 bar to about 8 bar, from about 0.1 bar to about 6 bar, from about 0.1 bar to about 4 bar, from about 0.1 bar to about 2 bar, from about 0.1 bar to about 1 bar, from about 0.5 bar to about 10 bar, from about 0.5 bar to about 8 bar, from about 0.5 bar to about 6 bar, from about 0.5 bar to about 4 bar, from about 0.5 bar to about 2 bar, or from about 0.5 bar to about 1 bar, such as about 0.9 or about 0.95 bar. The transmembrane pressure driving the water filtration can be provided by any suitable device, such as a pump (see, e.g., pump 2700 shown in FIG. 6).

The water is fed into the filtration system, such as the gravity-driven system or vacuum-driven system and passes through the nanofiltration membrane contained therein. The water can pass through the nanofiltration membrane following any suitable flow path, such as substantially perpendicular to the plane of the membrane surface that is in contact with the feed water (which is the water prior to filtration) or at an angle relative to the plane of the membrane surface that is in contact with the feed water. For example, as shown in FIG. 5, the nanofiltration membrane 1100 is positioned in the gravity-driven membrane module 1200 such that the membrane surface 1110 in contact with the feed solution 1400 is in a plane that is in parallel with the bottom of the water tank. As such, driven by a hydraulic pressure provided by the water head, the feed solution 1400 passes through the nanofiltration membrane 1100 in a flow path that is perpendicular to the plane of the membrane surface 1110.

Methods for filtering water using the gravity-driven system, having any of the water head and/or cross-flow velocity described above, can achieve an ion/contaminant rejection rate of at least 70%, at least 75%, at least 80%, or at least 85% against a target ion/contaminant, such as a divalent ion, a multivalent ion, a heavy metal, or an organic micropollutant, or a combination thereof; and/or a water flux of at least 1 L m⁻² h⁻¹, at least 2 L m⁻² h⁻¹, at least 3 L m⁻² h⁻¹, in a range from about 1 L m⁻² h⁻¹ to about 20 L m⁻² h⁻¹, from about 1 L m⁻² h⁻¹ to about 15 L m⁻² h⁻¹, from about 1 L m⁻² h⁻¹ to about 10 L m⁻² h⁻¹, from about 1 L m⁻² h⁻¹ to about 5 L m⁻² h⁻¹, from about 2 L m⁻² h⁻¹ to about 20 L m⁻² h⁻¹, from about 2 L m⁻² h⁻¹ to about 15 L m⁻² h⁻¹, from about 2 L m⁻² h⁻¹ to about 10 L m⁻² h⁻¹, or from about 2 L m⁻² h⁻¹ to about 5 L m⁻² h⁻¹, such as about 4.5 L m⁻² h⁻¹.

For example, the methods for filtering water using the gravity-driven system, having any of the water head and/or cross-flow velocity described above, achieves an ion rejection rate of at least 70%, at least 75%, at least 80%, or at least 85% against a target ion, such as a divalent ion (e.g., sulfate ion, magnesium ion, calcium ion, etc.) or a multivalent ion, or a combination thereof; and/or a water flux of at least 1 L m⁻² h⁻¹, at least 2 L m⁻² h⁻¹, at least 3 L m⁻² h⁻¹, in a range from about 1 L m⁻² h⁻¹ to about 20 L m⁻² h⁻¹, from about 1 L m⁻² h⁻¹ to about 15 L m⁻² h⁻¹, from about 1 L m⁻² h⁻¹ to about 10 L m⁻² h⁻¹, from about 1 L m⁻² h⁻¹ to about 5 L m⁻² h⁻¹, from about 2 L m⁻² h⁻¹ to about 20 L m⁻² h⁻¹, from about 2 L m⁻² h⁻¹ to about 15 L m⁻² h⁻¹, from about 2 L m⁻² h⁻¹ to about 10 L m⁻² h⁻¹, or from about 2 L m⁻² h⁻¹ to about 5 L m⁻² h⁻¹, such as about 4.5 L m⁻² h⁻¹.

Methods for filtering water using the vacuum-driven system, having any of the transmembrane pressure described above, can achieve an ion/contaminant rejection rate of at least 90%, at least 92%, at least 95%, or at least 96% against a target ion/contaminant, such as a divalent ion, a multivalent ion, a heavy metal, or an organic micropollutant, or a combination thereof; and/or a water flux of at least 30 L m⁻² h⁻¹, at least 35 L m⁻² h⁻¹, in a range from about 30 L m⁻² h⁻¹ to about 200 L m⁻² h⁻¹, from about 30 L m⁻² h⁻¹ to about 150 L m⁻² h⁻¹, from about 30 L m⁻² h⁻¹ to about 100 L m⁻² h⁻¹, from about 30 L m⁻² h⁻¹ to about 80 L m⁻² h⁻¹, or from about 30 L m⁻² h⁻¹ to about 50 L m⁻² h⁻¹, such as about 38 L m⁻² h⁻¹.

For example, the methods for filtering water using the vacuum-driven system, having any of the transmembrane pressure described above, achieves an ion rejection rate of at least 90%, at least 92%, at least 95%, or at least 96% against a target ion, such as a divalent ion (e.g., sulfate ion, magnesium ion, calcium ion, etc.) or a multivalent ion, or a combination thereof; and/or a water flux of at least 30 L m⁻² h⁻¹, at least 35 L m⁻² h⁻¹, in a range from about 30 L m⁻² h⁻¹ to about 200 L m⁻² h⁻¹, from about 30 L m⁻² h⁻¹ to about 150 L m⁻² h⁻¹, from about 30 L m⁻² h⁻¹ to about 100 L m⁻² h⁻¹, from about 30 L m⁻² h⁻¹ to about 80 L m⁻² h⁻¹, or from about 30 L m⁻² h⁻¹ to about 50 L m⁻² h⁻¹, such as about 38 L m⁻² h⁻¹.

The disclosed nanofiltration membranes, systems, methods of making, and method of using can be further understood through the following numbered paragraphs.

Paragraph 1. A nanofiltration membrane for filtering water comprising a silk layer, wherein the silk layer comprises silk nanomaterials.

Paragraph 2. The nanofiltration membrane of paragraph 1, wherein the silk nanomaterials comprise fibroin.

Paragraph 3. The nanofiltration membrane of paragraph 1 or 2, wherein the silk nanomaterials are in the form of fibers, foams, meshes, or sponges, or a combination thereof.

Paragraph 4. The nanofiltration membrane of any one of paragraphs 1-3, wherein the silk nanomaterials are in the form of fibers, such as nanofibers.

Paragraph 5. The nanofiltration membrane of any one of paragraphs 1-4, wherein the silk nanomaterials are silk fibers, and optionally wherein the silk fibers have an average diameter in a range from about 10 μm to about 60 μm, from about 10 μm to about 50 μm, from about 10 μm to about 40 μm, from about 10 μm to about 30 μm, or from about 20 μm to about 40 μm.

Paragraph 6. The nanofiltration membrane of paragraph any one of paragraphs 1-5, wherein the silk layer further comprises a collogen or a polymer, or a combination thereof.

Paragraph 7. The nanofiltration membrane of paragraph 6, wherein the collogen is in the form of fibers, foams, meshes, or sponges, or a combination thereof.

Paragraph 8. The nanofiltration membrane of any one of paragraphs 1-7, wherein the silk nanomaterials have a weight loading in a range from about 40 μg/cm² to about 150 μg/cm² in the nanofiltration membrane.

Paragraph 9. The nanofiltration membrane of any one of paragraphs 1-8, wherein the silk layer is porous with an average pore diameter in a range from about 10 nm to about 1.5 μm, from about 20 nm to about 1.2 μm, from about 20 nm to about 0.8 μm, from about 20 nm to about 0.6 μm, from about 50 nm to about 1.5 μm, from about 50 nm to about 1.0 μm, from about 50 nm to about 0.8 μm, from about 0.1 μm to about 1.5 μm, from about 0.2 μm to about 1.5 μm, or from 0.5 μm to about 1.5 μm.

Paragraph 10. The nanofiltration membrane of any one of paragraphs 1-9, wherein the silk layer has a thickness in a range from about 100 nm to about 100 μm, from about 1 μm to about 100 μm, from about 10 μm to about 100 μm, from about 10 to about 80 μm, from about 20 μm to about 100 μm, or from about 20 μm to about 80 μm.

Paragraph 11. The nanofiltration membrane of any one of paragraphs 1-9, wherein the silk layer has a transport rate in a range from about 160 L m⁻² h⁻¹ bar⁻¹ to about 16000 L m⁻² h⁻¹ bar⁻¹, from about 500 to about 16000 L m⁻² h⁻¹ bar⁻¹, from about 1000 to about 16000 L m⁻² h⁻¹ bar⁻¹, from about 1600 to about 16000 L m⁻² h⁻¹ bar⁻¹, from about 3200 to about 16000 L m⁻² h⁻¹ bar⁻¹, from about 4800 to about 16000 L m⁻² h⁻¹ bar⁻¹, from about 6000 to about 16000 L m⁻² h⁻¹ bar⁻¹, or from about 10000 to about 16000 L m⁻² h⁻¹ bar⁻¹.

Paragraph 12. The nanofiltration membrane of any one of paragraphs 1-11, wherein the nanofiltration membrane further comprises a porous substrate, and wherein a first surface of the silk layer is in contact with a first contact surface of the porous substrate.

Paragraph 13. The nanofiltration membrane of paragraph 12, wherein the porous substrate is an organic polymer support, a hollow fiber support, a metal support, an inorganic support, or an organic-inorganic hybrid support.

Paragraph 14. The nanofiltration membrane of paragraph 12 or 13, wherein the porous substrate comprises a polymer selected from the group consisting of poly(vinylidene fluoride), polysulfone, poly(ether sulfone), poly(ether ketone) (e.g., poly(ether ether ketone), poly(ether ketone ketone), poly(ether ether ketone ketone), poly(ether ketone ether ketone ketone), etc.), polyacrylonitrile, polypropylene, polyester, polytetrafluoroethylene, poly(arylene ether nitrile ketone), polyamide, polyimide, poly(vinyl chloride), polyaniline, polybenzimidazole, poly(methyl methacrylate), poly(2-hydroxyethyl methacrylate), and poly(phthalazione ether nitrile ketone), or a copolymer thereof, a hydrophilic-modified polymer thereof (e.g., hydroxyl-, carboxyl-, amine-, glutaraldehyde-, sulfone-, or acrylic acid-modified polymer thereof), or a blend thereof;
an inorganic material selected from the group consisting of alumina, titanium dioxide, molybdenum disulfide, MXene, silica nanoparticles, zeolite nanoparticles, and ceramic; or
a carbon material selected from the group consisting of graphene oxide, hydrophilic-modified graphene oxide, and hydrophilic-modified carbon nanotubes, or
a combination thereof.

Paragraph 15. The nanofiltration membrane of any one of paragraphs 12-14, wherein the porous substrate has an average pore diameter in a range from about 20 nm to about 10 μm, from about 20 nm to about 8 μm, from about 20 nm to about 5 μm, from about 20 nm to about 1 μm, from about 20 nm to about 0.8 μm, or from about 20 nm to about 0.6 μm.

Paragraph 16. The nanofiltration membrane of any one of paragraphs 12-15, wherein the substrate has a thickness in a range from about 1 μm to about 500 μm, from about 1 μm to about 200 μm, from about 10 μm to about 500 μm, from about 10 μm to about 200 μm, from about 20 μm to about 500 μm, from about 20 μm to about 200 μm, from about 50 μm to about 500 μm, from about 50 μm to about 200 μm, from about 100 μm to about 500 μm, or from about 100 μm to about 200 μm.

Paragraph 17. The nanofiltration membrane of any one of paragraphs 12-16, wherein the nanofiltration membrane further comprises a selective layer, and wherein a second surface of the silk layer is in contact with a second contact surface of the selective layer, wherein the second surface of the silk layer is opposite the first surface of the silk layer.

Paragraph 18. The nanofiltration membrane of paragraph 17, wherein the selective layer comprises poly(ether sulfone), polyester, or polyamide, or a copolymer thereof, a modified polymer thereof, or a blend thereof.

Paragraph 19. The nanofiltration membrane of paragraph 17 or 18, wherein the selective layer has an average pore diameter in a range from about 0.5 nm to about 2 nm, from about 1 nm to about 2 nm, from about 0.5 nm to about 1.5 nm, from about 1 nm to about 1.5 nm, or from about 0.5 nm to about 1 nm.

Paragraph 20. The nanofiltration membrane of any one of paragraphs 17-19, wherein the selective layer has a thickness in a range from about 5 nm to about 1000 nm, from about 5 nm to about 800 nm, from about 5 nm to about 500 nm, from about 5 nm to about 250 nm, from about 5 nm to about 200 nm, from about 5 nm to about 150 nm, from about 5 nm to about 100 nm, from about 5 nm to about 80 nm, from about 5 nm to about 50 nm, from about 10 nm to about 1000 nm, from about 10 nm to about 800 nm, from about 10 nm to about 500 nm, from about 10 nm to about 250 nm, from about 10 nm to about 200 nm, from about 10 nm to about 150 nm, from about 10 nm to about 100 nm, from about 50 nm to about 1000 nm, from about 50 nm to about 800 nm, from about 50 nm to about 500 nm, from about 50 nm to about 250 nm, from about 50 nm to about 200 nm, from about 50 nm to about 150 nm, from about 50 nm to about 100 nm, from about 100 nm to about 1000 nm, from about 100 nm to about 800 nm, from about 100 nm to about 500 nm, from about 100 nm to about 250 nm, or from about 100 nm to about 200 nm.

Paragraph 21. The nanofiltration membrane of any one of paragraphs 1-20, wherein the nanofiltration membrane is neutral in charge, positively charged, or negatively charged, optionally wherein the nanofiltration membrane is negatively charged.

Paragraph 22. The nanofiltration membrane of any one of paragraphs 1-21, wherein the nanofiltration membrane is in the form of a long cylinder, a sheet, or a monolithic.

Paragraph 23. The nanofiltration membrane of any one of paragraphs 1-22, wherein the nanofiltration membrane has a water permeance of at least 15 L m⁻² h⁻¹ bar⁻¹, at least 20 L m⁻² h⁻¹ bar⁻¹ at least 25 L m⁻² h⁻¹ bar⁻¹, in a range from about 15 L m⁻² h⁻¹ bar⁻¹ to about 150 L m⁻² h⁻¹ bar⁻¹, from about 20 L m⁻² h⁻¹ bar⁻¹ to about 150 L m⁻² h⁻¹ bar⁻¹, from about 15 L m⁻² h⁻¹ bar⁻¹ to about 100 L m⁻² h⁻¹ bar⁻¹, or from about 20 L m⁻² h⁻¹ bar⁻¹ to about 100 L m⁻² h⁻¹ bar⁻¹.

Paragraph 24. The nanofiltration membrane of any one of paragraphs 1-23, wherein the nanofiltration membrane has a water permeance that is at least 2-fold, at least 3-fold, at least 4-fold, or at least 5-fold of the water permeance of a commercially available nanofiltration membrane, such as DuPont FilmTec™ NF270 and/or DuPont FilmTec™ NF90, when tested under the same condition.

Paragraph 25. The nanofiltration membrane of any one of paragraphs 1-24, wherein the nanofiltration membrane has an ion rejection rate of at least 90%, at least 95%, at least 97%, or at least 98% against a target ion, optionally wherein the target ion is a divalent ion or a multivalent ion, or a combination thereof.

Paragraph 26. The nanofiltration membrane of paragraph 25, wherein the target ion is a divalent ion, such as a sulfate ion, magnesium ion, or calcium ion, or a combination thereof.

Paragraph 27. A method of making the nanofiltration membrane of any one of paragraphs 12-26, comprising: (i) spraying a suspension of the silk nanomaterials onto the first contact surface of the porous substrate to form a silk layer coated porous substrate.

Paragraph 28. The method of paragraph 27, wherein step (i) is performed using a vacuum-assisted device, such as a nitrogen spray gun.

Paragraph 29. The method of paragraph 27 or 28, wherein during step (i), the silk nanomaterials in the suspension has a volume loading in a range from about 0.01 mL cm⁻² to about 20 mL cm⁻², from about 0.05 mL cm⁻² to about 20 mL cm⁻², from about 0.1 mL cm⁻² to about 20 mL cm⁻², from about 0.2 mL cm⁻² to about 20 mL cm⁻², from about 0.01 mL cm⁻² to about 10 mL cm⁻², from about 0.05 mL cm⁻² to about 10 mL cm⁻², from about 0.1 mL cm⁻² to about 10 mL cm⁻², from about 0.2 mL cm⁻² to about 10 mL cm⁻², from about 0.2 mL cm⁻² to about 8 mL cm⁻², from about 0.2 mL cm⁻² to about 5 mL cm⁻², from about 0.2 mL cm⁻² to about 2 mL cm⁻², or from about 0.2 mL cm⁻² to about 1 mL cm⁻², such as about 0.3 mL cm⁻², about 0.5 mL cm⁻², or about 0.8 mL cm⁻².

Paragraph 30. The method of any one of paragraphs 27-29, wherein the method further comprises (a) preparing the suspension of the silk nanomaterials prior to step (i).

Paragraph 31. The method of paragraph 30, wherein step (a) comprises
(1) boiling a raw silk material in a base solution comprising a base to form a degummed silk material, optionally wherein the base has a concentration in a range from about 0.1 wt % to about 10 wt %, from about 0.1 wt % to about 5 wt %, from about 0.1 wt % to about 1 wt %, from about 1 wt % to about 10 wt %, from about 2 wt % to about 10 wt %, or from about 2 wt % to about 5 wt % of the base solution;
(2) mixing the degummed silk material with an acid to form a mixture, optionally wherein the acid has a concentration in a range from about 10 wt % to about 70 wt %, from about 20 wt % to about 60 wt %, or from about 30 wt % to about 50 wt %;
(3) heating the mixture at a temperature in a range from about 30 t to about 80° C., from about 40° C. to about 80° C., from about 50° C. to about 80° C., or from about 50° C. to about 70° C., for a time period in a range from about 30 minutes to about 300 minutes to form a suspension of the silk nanomaterials, optionally wherein the silk nanomaterials in the suspension are partially hydrolyzed.

Paragraph 32. The method of paragraph 31, wherein step (a) further comprises (4) diluting the suspension with water, (5) sonicating the suspension, and/or (6) removing fibrillated materials from the suspension.

Paragraph 33. The method of paragraph 31 or 32, wherein step (a) further comprises (7) adjusting the pH of the suspension to a pH in a range from 7 to 11.

Paragraph 34. The method of any one of paragraphs 27-33, wherein the method further comprises (b) heating the silk-layer coated porous substrate at a temperature in a range from about 30° C. to about 60° C., from about 40° C. to about 50° C., such as about 45° C., for a time period in a range from about 1 min to about 20 mins, from about 2 mins to about 20 mins, from about 5 mins to about 20 mins, from about 5 mins to about 15 mins, or from about 2 mins to about 10 mins, such as about 10 mins, after step (i).

Paragraph 35. The method of any one of paragraphs 27-34, wherein the method further comprises (ii) performing an interfacial polymerization reaction to form the selective layer onto the second surface of the silk layer of the silk layer coated porous substrate.

Paragraph 36. The method of paragraph 35, wherein the interfacial polymerization reaction is performed at room temperature (i.e. 20 to 25° C. at 1 atm) for a time period in a range from about 10 seconds to about 5 mins, from about 20 seconds to about 4 mins, from about 30 seconds to about 4 mins, from about 30 seconds to about 3 mins, from about 30 seconds to about 2 mins, or from 30 seconds to about 1 min, such as about 30 seconds or 60 seconds.

Paragraph 37. The method of paragraph 35 or 36, wherein the method further comprises
(c) contacting the second surface of the silk layer with an aqueous solution comprising an amine to form an amine coated silk layer, optionally wherein the amine has a concentration in a range from about 0.05 wt % to about 5 wt %, from about 0.1 wt % to about 5 wt %, from about 0.1 wt % to about 2 wt %, from about 0.1 wt % to about 1 wt %, such as about 0.1 wt % or about 0.5 wt %; and
(d) contacting the amine coated silk layer with an organic solution comprising an acid chloride to initiate the interfacial polymerization reaction, optionally wherein the acid chloride has a concentration in a range from about 0.05 wt % to about 1 wt %, from about 0.1 wt % to about 0.5 wt %, or from about 0.1 wt % to about 0.25 wt %, such as about 0.1 wt % or about 0.25 wt %,
wherein steps (c) and (d) are performed prior to step (ii) and after step (i).

Paragraph 38. The method of paragraph 37, wherein the method further comprises (e) removing an excess of the aqueous solution from the second surface of the silk layer, and wherein step (e) is performed after step (c) and prior to step (d).

Paragraph 39. The method of paragraph 37 or 38, wherein the amine is a diamine, optionally wherein the amine is an aromatic diamine or a cyclic aliphatic diamine.

Paragraph 40. The method of paragraph 37 or 38, wherein the amine is selected from the group consisting of meta-phenylene diamine (MPD), ortho-phenylene diamine (OPD), para-phenylene diamine (PPD), piperazine, bipiperidine, m-xylene diamine (MXDA), ethylenediamine, trimethylenediamine, hexamethylenediamine, diethylene triamine (DETA), triethylene tetramine (TETA), methane diamine (MDA), isophoronediamine (IPDA), triethanolamine, polyethyleneimine, methyl diethanolamine, and hydroxyalkylamine, or a combination thereof.

Paragraph 41. The method of any one of paragraphs 37-40, wherein the acid chloride is selected from the group consisting of monomers having an acyl chloride end-group, trimesoyl chloride (TMC), terephthaloyl chloride, isophthaloyl chloride, cyclohexane-1,3,5-tricarbonyl chloride, 5-isocyanato-isophthaloyl chloride, cyanuric chloride, trimellitoyl chloride, phosphoryl chloride, and glutaraldehyde, or a combination thereof.

Paragraph 42. A water filtration system comprising one or more of the nanofiltration membrane of paragraphs 1-26.

Paragraph 43. The water filtration system of paragraph 42, wherein the water filtration system is a gravity-driven system, and optionally wherein the gravity-driven system further comprises one or more gravity-driven membrane modules, each having one nanofiltration membrane or more than one nanofiltration membrane installed therein.

Paragraph 44. The water filtration system of paragraph 42, wherein the water filtration system is a vacuum-driven system, and optionally wherein the vacuum-driven system further comprises one or more submerged membrane modules, each having one nanofiltration membrane or more than one nanofiltration membrane inserted therein.

Paragraph 45. A method for filtering water using the water filtration system of paragraph 42, comprising feeding water into the water filtration system, optionally wherein the water is seawater, surface water, ground water, and/or wastewater.

Paragraph 46. The method of paragraph 45, wherein the method is to desalinate seawater, treat surface water, treat ground water, soften water, reuse water, treat industrial wastewater, and/or reclaim wastewater.

Paragraph 47. The method of paragraph 45 or 46, wherein the water has an osmotic pressure in a range from about 0.1 bar to about 10 bar, from about 0.1 bar to about 8 bar, from about 0.1 bar to about 6 bar, from 0.1 bar to about 4 bar, from 0.1 bar to about 2 bar, from 0.1 bar to about 1 bar, from about 0.1 bar to about 0.8 bar, from about 0.1 bar to about 0.6 bar, from about 0.1 bar to about 0.4 bar, or from about 0.1 bar to about 0.2 bar, such as about 0.19 bar or 0.95 bar.

Paragraph 48. The method of any one of paragraphs 45-47, wherein the water filtration system is a gravity-driven filtration system.

Paragraph 49. The method of paragraph 48, wherein the filtration is driven by a water head in a range from about 0.5 m to about 50 m, from about 0.5 m to about 30 m, from about 0.5 m to about 20 m, from about 0.5 m to about 10 m, from about 1 m to about 10 m, from about 1 m to about 8 m, from about 1 m to about 6 m, from about 1 m to about 5 m, or from about 1 m to about 3 m, such as about 3 m.

Paragraph 50. The method of paragraph 48 or 49, wherein the water is fed with a cross-flow velocity in a range from about 0.1 L h⁻¹ to about 100 L h⁻¹, from about 0.1 L h⁻¹ to about 80 L h⁻¹, from about 0.1 L h⁻¹ to about 50 L h⁻¹, from about 0.1 L h⁻¹ to about 20 L h⁻¹, from about 0.1 L h⁻¹ to about 10 L h⁻¹, from about 0.1 L h⁻¹ to about 8 L h⁻¹, from about 0.1 L h⁻¹ to about 6 L h⁻¹, from about 0.1 L h⁻¹ to about 5 L h⁻¹, from about 0.1 L h⁻¹ to about 3 L h⁻¹, from about 0.1 L h⁻¹ to about 2 L h⁻¹, from about 0.1 L h⁻¹ to about 1 L h⁻¹, from about 0.5 L h⁻¹ to about 5 L h⁻¹, from about 0.5 L h⁻¹ to about 3 L h⁻¹, from about 0.5 L h⁻¹ to about 2 L h⁻¹, or from about 0.5 L h⁻¹ to about 1 L h⁻¹, such as about 0.9 L h⁻¹.

Paragraph 51. The method of any one of paragraphs 48-50, wherein the water filtration system has an ion rejection rate of at least 70%, at least 75%, at least 80%, or at least 85% against a target ion, optionally wherein the target ion is a divalent ion or a multivalent ion, or a combination thereof.

Paragraph 52. The method of paragraph 51, wherein the target ion is a divalent ion, such as a sulfate ion, magnesium ion, or calcium ion, or a combination thereof.

Paragraph 53. The method of any one of paragraphs 48-52, wherein the water filtration system has a water flux of at least 1 L m⁻² h⁻¹, at least 2 L m⁻² h⁻¹, at least 3 L m⁻² h⁻¹, in a range from about 1 L m⁻² h⁻¹ to about 20 L m⁻² h⁻¹, from about 1 L m⁻² h⁻¹ to about 15 L m⁻² h⁻¹, from about 1 L m⁻² h⁻¹ to about 10 L m⁻² h⁻¹, from about 1 L m⁻² h⁻¹ to about 5 L m⁻² h⁻¹, from about 2 L m⁻² h⁻¹ to about 20 L m⁻² h⁻¹, from about 2 L m⁻² h⁻¹ to about 15 L m⁻² h⁻¹, from about 2 L m⁻² h⁻¹ to about 10 L m⁻² h⁻¹, or from about 2 L m⁻² h⁻¹ to about 5 L m⁻² h⁻¹, such as about 4.5 L m⁻² h⁻¹.

Paragraph 54. The method of any one of paragraphs 45-47, wherein the water filtration system is a vacuum-driven filtration system.

Paragraph 55. The method of paragraph 54, wherein the filtration is performed with a transmembrane pressure in a range from about 0.1 bar to about 10 bar, from about 0.1 bar to about 8 bar, from about 0.1 bar to about 6 bar, from about 0.1 bar to about 4 bar, from about 0.1 bar to about 2 bar, from about 0.1 bar to about 1 bar, from about 0.5 bar to about 10 bar, from about 0.5 bar to about 8 bar, from about 0.5 bar to about 6 bar, from about 0.5 bar to about 4 bar, from about 0.5 bar to about 2 bar, or from about 0.5 bar to about 1 bar, such as about 0.9 bar.

Paragraph 56. The method of paragraph 54 or 55, wherein the water filtration system has an ion rejection rate of at least 90%, at least 92%, at least 95%, or at least 96% against a target ion, optionally wherein the target ion is a divalent ion or a multivalent ion, or a combination thereof.

Paragraph 57. The method of paragraph 56, wherein the target ion is a divalent ion, such as a sulfate ion, magnesium ion, or calcium ion, or a combination thereof.

Paragraph 58. The method of any one of paragraphs 54-57, wherein the water filtration system has a water flux of at least 30 L m⁻² h⁻¹, at least 35 L m⁻² h⁻¹, in a range from about 30 L m⁻² h⁻¹ to about 200 L m⁻² h⁻¹, from about 30 L m⁻² h⁻¹ to about 150 L m⁻² h⁻¹, from about 30 L m⁻² h⁻¹ to about 100 L m⁻² h⁻¹, from about 30 L m⁻² h⁻¹ to about 80 L m⁻² h⁻¹, or from about 30 L m⁻² h⁻¹ to about 50 L m⁻² h⁻¹, such as about 38 L m⁻² h⁻¹.

### EXAMPLES

### Example 1. The Thin-Film Nanocomposite Nanofiltration Membrane (NFM) Containing a Layer of Silk Nanofibers (SNFs) Shows High Water Permeance and Removal Efficiency Against Contaminants

Materials and Methods

Preparation of SNFs suspension

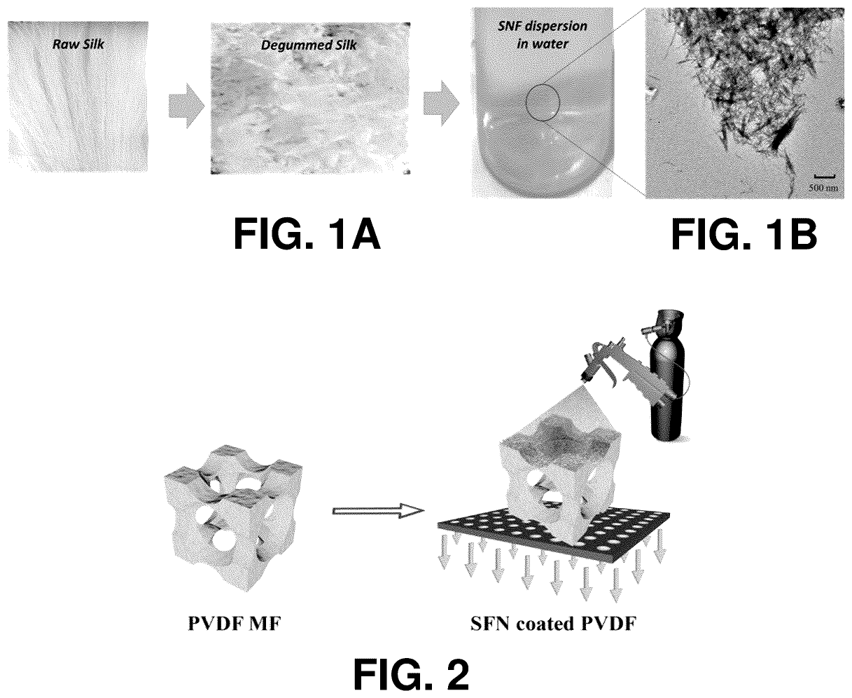

To prepare SNFs, raw silk was degummed by boiling it in aqueous solution that contains 0.5 wt. %-10 wt. % sodium carbonate to remove the sericin proteins. The degummed silk was mixed with 40 wt. % H₂SO₄ and the mixture was heated and kept at 60° C. to obtain a liquid suspension of partially hydrolyzed silk fibers. The liquid suspension was diluted with distilled water and mechanically disintegrated by ultrasonic homogenizer. After removing the fibrillated fraction from the liquid suspension, a SNFs suspension was obtained. To obtain well dispersed SNFs in water, the pH of the SNFs suspension was adjusted to 10 (see FIG. 1).

Preparation of NFM Using SNFs Suspension at a Volume Loading of 0.31 ml/cm² (NFM-1) and Performance Test of NFM-1

1. Pre-Loading SNF

20 ml of a diluted SNFs suspension at a volume loading of 0.31 ml/cm² were dispersed at pH 10 using ultrasonic cleaners. Subsequently, the diluted SNFs suspension was coated on the surface of a modified hydrophilic PVDF substrate by N₂ spray gun (see FIG. 2). The coated substrate was heated at 45° C. for 10 mins to enhance the stability of the SNFs interlayer. The concentration of SNFs in the suspension is about 0.129 g/L. The loading area of the PVDF substrate is about 63.5 cm². Thus, 20 ml of SNFs suspension contains about 2580 μg of SNFs, which provided a mass loading of about 41 μg/cm² SNFs on the PVDF substrate.

2. Constructing Polyamide Selective Layers

A layer of polyamide was constructed via interfacial polymerization reaction between amine-groups containing compounds in an aqueous phase and acryl chloride-groups containing compounds in an organic phase (FIGS. 3A-3B). A 0.5 wt. % piperazine (PIP) water solution was used as the amine aqueous phase (also referred herein as the “amine aqueous solution”). Trimesoyl chloride (TMC) was dissolved in hexane at a concentration of 0.1 wt. % as the organic phase (also referred herein as the “organic solution”). The SNFs layer of the SNFs coated PVDF substrate was soaked in the amine aqueous solution and any excessive amine aqueous solution was subsequently removed. The organic solution was quickly poured on the amine-soaked SNFs layer of the coated substrate to generate the polyamide layer on the SNFs layer and form the NFM-1. The interfacial polymerization reaction was performed for 60 seconds at room temperature.

3. Filtration Protocols and Separation Performances

The separation performance of NFM-1 was evaluated using 1 g/L Na₂SO₄ or 1 g/L NaCl solution under 0.6 Mpa in single salt mode.

Preparation of NFM Using SNFs Suspension at a Volume Loading of 0.47 ml/cm² (NFM-2) and Performance Test of NFM-2

NFM-2 was prepared and tested as described above for NFM-1, except that 30 ml of a SNFs suspension at a volume loading of 0.47 ml/cm² was used to prepare the SNFs layer of NFM-2. The concentration of SNFs in the suspension is about 0.129 g/L. The loading area of the PVDF substrate is about 63.5 cm². Thus, 30 ml of SNFs suspension contains about 3870 μg of SNFs, which provided a mass loading of about 61 μg/cm² SNFs on the PVDF substrate.

Preparation of NFM Using SNFs Suspension at a Volume Loading of 0.79 ml/cm² (NFM-3) and Performance Test of NFM-3

NFM-3 was prepared and tested as described above for NFM-1, except that 50 ml of a SNFs suspension at a volume loading of 0.79 ml/cm² was used to prepare the SNFs layer of NFM-3. The concentration of SNFs in the suspension is about 0.129 g/L. The loading area of the PVDF substrate is about 63.5 cm². Thus, 50 ml of SNFs suspension contains about 6450 μg of SNFs, which provided a mass loading of about 102 μg/cm² SNFs on the PVDF substrate.

Preparation of a Comparative NFM (NFM Control) and Performance Test of NFM Control

A NFM control was prepared and tested as described above for NFM-1, except that no SNFs layer was coated on the substrate and the interfacial polymerization reaction was performed directed on the PVDF substrate.

Preparation of NFM Using SNFs Suspension at a Volume Loading of 0.79 ml/cm² (NFM-5) and a PIP Water Solution at a Concentration of 0.1 wt. %, and Performance Test of NFM-5

NFM-5 was prepared as described above for NFM-1, except that a PIP water solution at a concentration of 0.1 wt. % was used to prepare the polyamide selective layer of NFM-5 and the interfacial polymerization reaction was performed for 30 seconds at room temperature.

The separation performance of NFM-5 was evaluated using 1 g/L Na₂SO₄ or 1 g/L NaCl solution under 0.3 Mpa in single salt mode.

Results

Scanning electron microcopy images of PVDF substrate, NFM-2, and NFM-5 are shown in FIGS. 4A-4C, respectively. As shown in FIG. 4A, the morphology of PVDF substrates with large surface pore size (>100 nm) was quite different from traditional substrates used in nanofiltration membrane fabrication (such as the use of ultrafiltration substrates of 2-100 nm surface pore size). The surface structures of the PVDF substrates were highly rough and had a number of leaf-like structures on the top surface. In contrast, as shown in FIGS. 4B and 4C, each of NFM-2 and NFM-5 contains a complete film, i.e., a coating of SNFs, on the PVDF substrates, while retaining the rough morphology of the substrates.

NFM-1 showed rejections to Na₂SO₄ and NaCl of 99.2% and 26.5% respectively. The pure water permeance of NFM-1 is 40.0 L·m⁻²h⁻¹bar⁻¹.

NFM-2 showed rejections to Na₂SO₄ and NaCl of 97.5% and 27.3% respectively. The pure water permeance of NFM-2 is 34.4 L·m⁻²h⁻¹bar⁻¹.

NFM-3 showed rejections to Na₂SO₄ and NaCl of 98.5% and 45.2% respectively. The pure water permeance of NFM-3 is 26.4 L·m⁻²h⁻¹bar⁻¹.

NFM control showed rejections to Na₂SO₄ and NaCl of 25.8% and 4.9% respectively. The pure water permeance of NFM control is 79.1 L·m⁻²h⁻¹bar⁻¹.

NFM-5 showed rejections to Na₂SO₄ and NaCl of 96.0% and 11.5% respectively. The pure water permeance of NFM-5 is 96.1 L·m⁻²h⁻¹bar⁻¹.

TABLE 1
The filtration performance of NFMs.

| | Permeance | Salts Rejection (%) | |
|---|---|---|---|
| Membrane | (L · m⁻² h⁻¹ bar⁻¹) | Na₂SO₄ | NaCl |
| NFM-1 | 40.0 | 99.2 | 26.5 |
| NFM-2 | 34.4 | 97.5 | 27.3 |
| NFM-3 | 26.4 | 98.5 | 45.2 |
| NFM control | 79.1 | 25.8 | 4.9 |
| NFM-5 | 96.1 | 96.0 | 11.5 |

### Example 2. NFM Integrated Gravity-Driven System Shows High Water Flux and Removal Efficiency Against Contaminants

Materials and Methods

NFM-6 was prepared as described above for NFM-5, expect that an organic solution containing 0.25 wt. % TMC was used to prepare the polyamide selective layer of NFM-6. NFM-6 was integrated in a gravity-driven system in dead-end or cross-flow mode.

The separation performance of NFM-6 was evaluated using a 0.5 g/L Na₂SO₄ feed solution (equivalent to an osmotic pressure of approximately 0.19 bar). A water head of 3 m was applied based on the height difference between the feed tank and gravity-driven filtration system. The cross-flow velocity was maintained at 0.92 L h⁻¹.

Results

The superhigh-permeance NFM-6 integrated gravity-driven system showed a rejection to Na₂SO₄ of 75.3%, and a water flux of 4.5 L·m⁻²h⁻¹.

### Example 3. NFM Integrated Vacuum-Driven System Shows High Water Flux and Removal Efficiency Against Contaminants

Materials and Methods

NFM-6 was prepared as described above and integrated in a vacuum-driven system.

The separation performance of the NFM-6 was evaluated by 0.5 g/L Na₂SO₄ feed solution (equivalent to an osmotic pressure of approximately 0.19 bar). A vacuum system provides a transmembrane pressure of 0.93 bar for the nanofiltration process.

Results

The superhigh-permeance NFM-6 integrated vacuum-driven system showed a rejection to Na₂SO₄ of 96.1%, and a water flux of 38.0 L·m⁻²h⁻¹.

We claim:

1. A nanofiltration membrane for filtering water comprising a silk layer, wherein the silk layer comprises silk nanomaterials.

2. The nanofiltration membrane of claim 1, wherein the silk nanomaterials comprise fibroin.

3. The nanofiltration membrane of claim 1, wherein the silk nanomaterials are in the form of fibers, foams, meshes, or sponges, or a combination thereof.

4. The nanofiltration membrane of claim 1, wherein the silk nanomaterials are in the form of nanofibers.

5. The nanofiltration membrane of claim 1, wherein the silk nanomaterials are silk fibers, and optionally wherein the silk fibers have an average diameter in a range from about 10 μm to about 60 μm, from about 10 μm to about 50 μm, from about 10 μm to about 40 μm, from about 10 μm to about 30 μm, or from about 20 μm to about 40 μm.

6. The nanofiltration membrane of claim 1, wherein the silk layer further comprises a collogen or a polymer, or a combination thereof.

7. The nanofiltration membrane of claim 6, wherein the collogen is in the form of fibers, foams, meshes, or sponges, or a combination thereof.

8. The nanofiltration membrane of claim 1, wherein the silk nanomaterials have a weight loading in a range from about 40 μg/cm² to about 150 μg/cm² in the nanofiltration membrane.

9. The nanofiltration membrane of claim 1, wherein the silk layer is porous with an average pore diameter in a range from about 10 nm to about 1.5 μm, from about 20 nm to about 1.2 μm, from about 20 nm to about 0.8 μm, from about 20 nm to about 0.6 μm, from about 50 nm to about 1.5 μm, from about 50 nm to about 1.0 μm, from about 50 nm to about 0.8 μm, from about 0.1 μm to about 1.5 μm, from about 0.2 μm to about 1.5 μm, or from 0.5 μm to about 1.5 μm.

10. The nanofiltration membrane of claim 1, wherein the silk layer has a thickness in a range from about 100 nm to about 100 μm, from about 1 μm to about 100 μm, from about 10 μm to about 100 μm, from about 10 μm to about 80 μm, from about 20 μm to about 100 μm, or from about 20 μm to about 80 μm.

11. The nanofiltration membrane of claim 1, wherein the silk layer has a transport rate in a range from about 160 L m⁻² h⁻¹ bar⁻¹ to about 16000 L m⁻² h⁻¹ bar⁻¹, from about 500 to about 16000 L m⁻² h⁻¹ bar⁻¹, from about 1000 to about 16000 L m⁻² h⁻¹ bar⁻¹, from about 1600 to about 16000 L m⁻² h⁻¹ bar⁻¹, from about 3200 to about 16000 L m⁻² h⁻¹ bar⁻¹, from about 4800 to about 16000 L m⁻² h⁻¹ bar⁻¹, from about 6000 to about 16000 L m⁻² h⁻¹ bar⁻¹, or from about 10000 to about 16000 L m⁻² h⁻¹ bar⁻¹.

12. The nanofiltration membrane of claim 1, wherein the nanofiltration membrane further comprises a porous substrate, and wherein a first surface of the silk layer is in contact with a first contact surface of the porous substrate, optionally wherein the porous substrate has a porosity of at least 10%.

13. The nanofiltration membrane of claim 12, wherein the porous substrate is an organic polymer support, a hollow fiber support, a metal support, an inorganic support, or an organic-inorganic hybrid support.

14. The nanofiltration membrane of claim 12, wherein the porous substrate comprises a polymer selected from the group consisting of poly(vinylidene fluoride), polysulfone, poly(ether sulfone), poly(ether ketone) (e.g., poly(ether ether ketone), poly(ether ketone ketone), poly(ether ether ketone ketone), poly(ether ketone ether ketone ketone), etc.), polyacrylonitrile, polypropylene, polyester, polytetrafluoroethylene, poly(arylene ether nitrile ketone), polyamide, polyimide, poly(vinyl chloride), polyaniline, polybenzimidazole, poly(methyl methacrylate), poly(2-hydroxyethyl methacrylate), and poly(phthalazione ether nitrile ketone), or a copolymer thereof, a hydrophilic-modified polymer thereof (e.g., hydroxyl-, carboxyl-, amine-, glutaraldehyde-, sulfone-, or acrylic acid-modified polymer thereof), or a blend thereof;
an inorganic material selected from the group consisting of alumina, titanium dioxide, molybdenum disulfide, MXene, silica nanoparticles, zeolite nanoparticles, and ceramic; or
a carbon material selected from the group consisting of graphene oxide, hydrophilic-modified graphene oxide, and hydrophilic-modified carbon nanotubes, or
a combination thereof.

15. The nanofiltration membrane of claim 12, wherein the porous substrate has an average pore diameter in a range from about 20 nm to about 10 μm, from about 20 nm to about 8 μm, from about 20 nm to about 5 μm, from about 20 nm to about 1 μm, from about 20 nm to about 0.8 μm, or from about 20 nm to about 0.6 μm.

16. The nanofiltration membrane of claim 12, wherein the substrate has a thickness in a range from about 1 μm to about 500 μm, from about 1 μm to about 200 μm, from about 10 μm to about 500 μm, from about 10 μm to about 200 μm, from about 20 μm to about 500 μm, from about 20 μm to about 200 μm, from about 50 μm to about 500 μm, from about 50 μm to about 200 μm, from about 100 μm to about 500 μm, or from about 100 μm to about 200 μm.

17. The nanofiltration membrane of claim 12, wherein the nanofiltration membrane further comprises a selective layer, and wherein a second surface of the silk layer is in contact with a second contact surface of the selective layer, wherein the second surface of the silk layer is opposite the first surface of the silk layer.

18. The nanofiltration membrane of claim 17, wherein the selective layer comprises poly(ether sulfone), polyester, or polyamide, or a copolymer thereof, a modified polymer thereof, or a blend thereof.

19. The nanofiltration membrane of claim 17, wherein the selective layer has an average pore diameter in a range from about 0.5 nm to about 2 nm, from about 1 nm to about 2 nm, from about 0.5 nm to about 1.5 nm, from about 1 nm to about 1.5 nm, or from about 0.5 nm to about 1 nm.

20. The nanofiltration membrane of claim 17, wherein the selective layer has a thickness in a range from about 5 nm to about 1000 nm, from about 5 nm to about 800 nm, from about 5 nm to about 500 nm, from about 5 nm to about 250 nm, from about 5 nm to about 200 nm, from about 5 nm to about 150 nm, from about 5 nm to about 100 nm, from about 5 nm to about 80 nm, from about 5 nm to about 50 nm, from about 10 nm to about 1000 nm, from about 10 nm to about 800 nm, from about 10 nm to about 500 nm, from about 10 nm to about 250 nm, from about 10 nm to about 200 nm, from about 10 nm to about 150 nm, from about 10 nm to about 100 nm, from about 50 nm to about 1000 nm, from about 50 nm to about 800 nm, from about 50 nm to about 500 nm, from about 50 nm to about 250 nm, from about 50 nm to about 200 nm, from about 50 nm to about 150 nm, from about 50 nm to about 100 nm, from about 100 nm to about 1000 nm, from about 100 nm to about 800 nm, from about 100 nm to about 500 nm, from about 100 nm to about 250 nm, or from about 100 nm to about 200 nm.

21. The nanofiltration membrane of claim 1, wherein the nanofiltration membrane is neutral in charge, positively charged, or negatively charged, optionally wherein the nanofiltration membrane is negatively charged.

22. The nanofiltration membrane of claim 1, wherein the nanofiltration membrane is in the form of a long cylinder, a sheet, or a monolithic.

23. The nanofiltration membrane of claim 1, wherein the nanofiltration membrane has a water permeance of at least 15 L m⁻² h⁻¹ bar⁻¹, at least 20 L m⁻² h⁻¹ bar⁻¹, at least 25 L m⁻² h⁻¹ bar⁻¹, in a range from about 15 L m⁻² h⁻¹ bar⁻¹ to about 150 L m⁻² h⁻¹ bar⁻¹, from about 20 L m⁻² h⁻¹ bar⁻¹ to about 150 L m⁻² h⁻¹ bar⁻¹, from about 15 L m⁻² h⁻¹ bar⁻¹ to about 100 L m⁻² h⁻¹ bar⁻¹, or from about 20 L m⁻² h⁻¹ bar⁻¹ to about 100 L m⁻² h⁻¹ bare.

24. The nanofiltration membrane of claim 1, wherein the nanofiltration membrane has a water permeance that is at least 2-fold, at least 3-fold, at least 4-fold, or at least 5-fold of the water permeance of a commercially available nanofiltration membrane, such as DuPont FilmTec™ NF270 and/or DuPont FilmTec™ NF90, when tested under the same condition.

25. The nanofiltration membrane of claim 1, wherein the nanofiltration membrane has an ion rejection rate of at least 90%, at least 95%, at least 97%, or at least 98% against a target ion, optionally wherein the target ion is a divalent ion or a multivalent ion, or a combination thereof.

26. The nanofiltration membrane of claim 25, wherein the target ion is a divalent ion, such as a sulfate ion, magnesium ion, or calcium ion, or a combination thereof.

27. A water filtration system comprising one or more of the nanofiltration membrane of claim 1.

28. The water filtration system of claim 27, wherein the water filtration system is a gravity-driven system, and optionally wherein the gravity-driven system further comprises one or more gravity-driven membrane modules, each having one nanofiltration membrane or more than one nanofiltration membrane installed therein; or
wherein the water filtration system is a vacuum-driven system, and optionally wherein the vacuum-driven system further comprises one or more submerged membrane modules, each having one nanofiltration membrane or more than one nanofiltration membrane inserted therein.

29. A method of making the nanofiltration membrane of claim 17, comprising: (i) spraying a suspension of the silk nanomaterials onto the first contact surface of the porous substrate to form a silk layer coated porous substrate, and (ii) performing an interfacial polymerization reaction to form the selective layer onto the second surface of the silk layer of the silk layer coated porous substrate.

30. A method for filtering water using the water filtration system of claim 27, comprising feeding water into the water filtration system, optionally wherein the water is seawater, surface water, ground water, and/or wastewater.
